(19) United States
(12) Patent Application Publication
(10) Pub. No.: US 2018/0061163 A1
(43) Pub. Date: Mar. 1, 2018

(54) CONTROL DEVICE FOR A DOOR LOCK

(71) Applicant: CANDY HOUSE INC., Palo Alto, CA (US)

(72) Inventor: Che-Ming KU, Taichung City (TW)

(21) Appl. No.: 15/686,859

(22) Filed: Aug. 25, 2017

(30) Foreign Application Priority Data
Aug. 30, 2016 (TW) 105127795
Aug. 14, 2017 (TW) 106127425

(51) Int. Cl. G07C 9/00; E05B 47/00; E05B 9/02; E05B 63/00

(52) U.S. Cl. CPC G07C 9/00896; E05B 47/0012; E05B 9/02; E05B 2047/0091; E05B 2047/0095; E05B 2047/002; E05B 63/0056

(57) ABSTRACT

A control device for operating a rotary button of a door lock disposed on a door leaf, and includes a casing unit and a control unit. The casing unit includes a carrying module corresponding in position to the rotary button, and a supporting module mounted to the door leaf and movable relative to the carrying module in at least one of two directions perpendicular to each other. The control unit includes an operating mechanism associated with the rotary button, a transmission mechanism associated with the operating mechanism, and a driving mechanism associated with the transmission mechanism, and capable of receiving a wireless signal to actuate the operating mechanism via the transmission mechanism, so as to operate the rotary button.

### CROSS-REFERENCE TO RELATED APPLICATION

This application claims priority of Taiwanese Patent Application No. 105127795, filed on Aug. 30, 2016, and priority of Taiwanese Patent Application No. 106127425, filed on Aug. 14, 2017.

### FIELD

The disclosure relates to a control device, and more particularly to a control device for a door lock.

### BACKGROUND

Referring to FIGS. 1 and 2, a conventional remote control device 93 (see FIG. 2) is for operating a door lock 91. The door lock 91 is disposed on a door leaf 92, and includes a base seat 911, a latch member 913 movably mounted to the base seat 911, and a rotary button 912 rotatably mounted to the base seat 911 and operable to drive movement of the latch member 913 relative to the base seat 911. The conventional remote control device 93 is mounted on an outer surface 911a of the base seat 911 of the door lock 91, and receives a wireless signal emitted from a mobile phone to rotate the rotary button 912 so as to move the latch member 913. However, since different door locks vary in shape, the conventional remote control device 93 may not be suitable for various kinds of door locks. For example, a space may be formed between the conventional remote control device 93 and the door leaf 92 (see FIG. 2).

### SUMMARY

Therefore, an object of the disclosure is to provide a control device for operating a door lock that can alleviate the drawback of the prior art.

According to an aspect of the disclosure, the control device is for operating a door lock that is disposed on a door leaf. The door lock includes a base seat that is mounted on and protrudes from an outer surface of the door leaf, and a rotary button that is rotatably mounted to and protrudes from an outer surface of the base seat. The control device includes a casing unit and a control unit. The casing unit includes a carrying module that corresponds in position to the rotary button, and a supporting module that is connected to the carrying module and that is mounted to the outer surface of the door leaf. The carrying module has an inner surface that faces the outer surface of the base seat. The supporting module is movable relative to the carrying module in at least one of a first direction that is perpendicular to the inner surface, and a second direction that is parallel to the inner surface. The control unit is disposed on the casing unit, and includes an operating mechanism, a transmission mechanism and a driving mechanism. The operating mechanism is mounted to the carrying module and is associated with the rotary button of the door lock for operating the rotary button. The transmission mechanism is associated with the operating mechanism. The driving mechanism is associated with the transmission mechanism, and is capable of receiving a wireless signal to actuate the operating mechanism via the transmission mechanism, so as to operate the rotary button.

According to another aspect of the disclosure, the control device is for operating a door lock that is disposed on a door leaf. The door lock includes a base seat that is mounted on and protrudes from an outer surface of the door leaf, and a rotary button that is rotatably mounted to and protrudes from an outer surface of the base seat. The control device includes a casing unit and a control unit. The casing unit includes a carrying module that corresponds in position to the rotary button, and a supporting module that is connected to the carrying module and that is mounted to the outer surface of the door leaf. The carrying module has an inner surface that faces the outer surface of the base seat. The supporting module is movable relative to the carrying module in a first direction that is perpendicular to the inner surface, and a second direction that is parallel to the inner surface. The carrying module includes a casing seat, and a cover plate that has the inner surface. The casing seat cooperates with the cover plate to define a retaining space, an installation portion and a connecting portion. The supporting module includes a connecting seat, a fixing seat and a receiving box. The connecting seat is movably sleeved on the connecting portion of the carrying module, and is movable relative to the carrying module in the second direction. The fixing seat is fixedly connected to the connecting seat. A distance between the fixing seat and the door leaf is smaller than that between the inner surface of the carrying module and the door leaf. The receiving box is able to be retained in the fixing seat, and is movable relative to the fixing seat in the first direction, so that the receiving box is movable relative to the carrying module in the first direction. The control unit is disposed on the casing unit, and includes an operating mechanism, a transmission mechanism and a driving mechanism. The operating mechanism is mounted to the installation portion of the carrying module and is associated with the rotary button of the door lock for operating the rotary button. The transmission mechanism includes a driven gear that is connected to the operating mechanism, a driving gear that is connected to the driving mechanism, and a plurality of intermediate gears that are disposed between and mesh with the driving gear and the driven gear for transmitting power from the driving gear to the driven gear. The intermediate gears are moved during the relative movement between the carrying module and the connecting seat so as to be maintained to transmit power from the driving gear to the driven gear. The driving mechanism is associated with the transmission mechanism, and is capable of receiving a wireless signal to actuate the operating mechanism via the transmission mechanism, so as to operate the rotary button.

According to still another aspect of the disclosure, the control device is for operating a door lock that is disposed on a door leaf. The door lock includes a base seat that is mounted on and protrudes from an outer surface of the door leaf, and a rotary button that is rotatably mounted to and protrudes from an outer surface of the base seat. The control device includes a casing unit and a control unit. The casing unit includes a carrying module that corresponds in position to the rotary button, and a supporting module that is connected to the carrying module and that is mounted to the outer surface of the door leaf. The carrying module has an inner surface that faces the outer surface of the base seat. The supporting module is movable relative to the carrying module in a first direction that is perpendicular to the inner surface, and a second direction that is parallel to the inner surface. The carrying module includes a casing seat, and a cover plate that has the inner surface. The casing seat cooperates with the cover plate to define a retaining space, an installation portion and a connecting portion. The supporting module includes a connecting seat, a fixing seat and a cover seat. The connecting seat is movably sleeved by the connecting portion of the carrying module, and is movable relative to the carrying module in the second direction. The fixing seat is fixedly connected to the connecting seat. A distance between the fixing seat and the door leaf is smaller than that between the inner surface of the carrying module and the door leaf. The cover seat is able to receive the fixing seat therein, and is movable relative to the fixing seat in the first direction, so that the cover seat is movable relative to the carrying module in the first direction. The control unit is disposed on the casing unit, and includes an operating mechanism, a transmission mechanism and a driving mechanism. The operating mechanism is mounted to the installation portion of the carrying module and is associated with the rotary button of the door lock for operating the rotary button. The transmission mechanism includes a driven gear that is connected to the operating mechanism, a driving gear that is connected to the driving mechanism, and a plurality of intermediate gears that are disposed between and mesh with the driving gear and the driven gear for transmitting power from the driving gear to the driven gear. The intermediate gears are moved during the relative movement between the carrying module and the connecting seat so as to be maintained to transmit power from the driving gear to the driven gear. The driving mechanism is associated with the transmission mechanism, and is capable of receiving a wireless signal to actuate the operating mechanism via the transmission mechanism, so as to operate the rotary button.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary side view illustrating a door lock mounted on a door leaf;

FIG. 2 is a fragmentary side view illustrating a conventional remote control device mounted on the door lock;

FIG. 3 is a perspective view illustrating a first embodiment of the control device according to the disclosure;

FIG. 4 is another perspective view illustrating the first embodiment;

FIG. 5 is a partly exploded perspective view illustrating the first embodiment with some components being omitted;

FIG. 6 is another partly exploded perspective view illustrating the first embodiment;

FIG. 7 is still another partly exploded perspective view illustrating the first embodiment;

FIG. 8 is still another partly exploded perspective view illustrating the first embodiment;

FIG. 9 is still another partly exploded perspective view illustrating the first embodiment;

FIG. 10 is still another partly exploded perspective view illustrating the first embodiment;

FIG. 11 is still another partly exploded perspective view illustrating the first embodiment;

FIG. 12 is an exploded perspective view illustrating a receiving box of the first embodiment;

FIG. 13 is a sectional view illustrating the first embodiment;

FIG. 14 is a schematic perspective view illustrating the receiving box projecting out of a fixing seat;

FIG. 15 is a schematic sectional view illustrating the receiving box projecting out of the fixing seat;

FIG. 16 is another schematic sectional view illustrating the first embodiment;

FIG. 17 is a schematic perspective view illustrating a connecting portion of a carrying module of the first embodiment projecting out of a connecting seat;

FIG. 18 is a schematic sectional view illustrating the connecting portion of the carrying module projecting out of the connecting seat;

FIG. 19 is a schematic side view illustrating the connecting portion of the carrying module projecting out of the connecting seat;

FIG. 20 is another schematic side view illustrating the connecting portion of the carrying module projecting out of the connecting seat;

FIG. 21 is a schematic perspective view illustrating the connecting portion of the carrying module projecting out of the connecting seat by a maximum extent;

FIG. 22 is another schematic perspective view illustrating the connecting portion of the carrying module projecting out of the connecting seat by a maximum extent;

FIG. 23 is a schematic sectional view illustrating the connecting portion of the carrying module projecting out of the connecting seat by a maximum extent;

FIG. 24 is a schematic side view illustrating the connecting portion of the carrying module projecting out of the connecting seat by a maximum extent;

FIG. 25 is another schematic side view illustrating the connecting portion of the carrying module projecting out of the connecting seat by a maximum extent;

FIG. 26 is a schematic perspective view illustrating the connecting portion of the carrying module projecting out of the connecting seat by a maximum extent and the receiving box projecting out of the fixing seat by a maximum extent;

FIG. 27 is a schematic side view illustrating the connecting portion of the carrying module projecting out of the connecting seat by a maximum extent and the receiving box projecting out of the fixing seat by a maximum extent;

FIG. 28 is a perspective view illustrating a second embodiment of the control device according to the disclosure;

FIG. 29 is another perspective view illustrating the second embodiment;

FIG. 30 is an exploded perspective view illustrating a carrying module and a supporting module of the second embodiment;

FIG. 31 is a perspective view illustrating a receiving box of the second embodiment;

FIG. 32 is a perspective view illustrating a third embodiment of the control device according to the disclosure;

FIG. 33 is a partly exploded perspective view illustrating a fixing seat of the third embodiment;

FIG. 34 is another partly exploded perspective view illustrating the third embodiment;

FIG. 35 is still another partly exploded perspective view illustrating the third embodiment;

FIG. 36 is still another partly exploded perspective view illustrating a latch module of the third embodiment;

FIG. 37 is a sectional view illustrating a supporting module of the third embodiment projecting relative to a carrying module of the third embodiment by a minimum extent, and the latch module of the third embodiment being released;

FIG. 38 is another sectional view illustrating the supporting module projecting relative to the carrying module by a minimum extent, and the latch module being depressed;

FIG. 39 is still another sectional view illustrating the supporting module projecting relative to the carrying module by a minimum extent;

FIG. 40 is a perspective view illustrating the supporting module projecting relative to the carrying module by a maximum extent;

FIG. 41 is a sectional view illustrating the supporting module projecting relative to the carrying module by a maximum extent, and the latch module being released;

FIG. 42 is another sectional view illustrating the supporting module projecting relative to the carrying module by a maximum extent;

FIG. 43 is a partly exploded perspective view illustrating a cover seat of the third embodiment;

FIG. 44 is a sectional view illustrating the fixing seat projecting relative to the cover seat by a minimum extent;

FIG. 45 is another sectional view illustrating the fixing seat projecting relative to the cover seat by a minimum extent;

FIG. 46 is a perspective view of illustrating the fixing seat projecting relative to the cover seat by a maximum extent;

FIG. 47 is a sectional view illustrating the fixing seat projecting relative to the cover seat by a maximum extent;

FIG. 48 is another sectional view illustrating the fixing seat projecting relative to the cover seat by a maximum extent; and

FIG. 49 is a perspective view of illustrating the supporting module projecting relative to the carrying module by a maximum extent, and the fixing seat projecting relative to the cover seat by a maximum extent.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

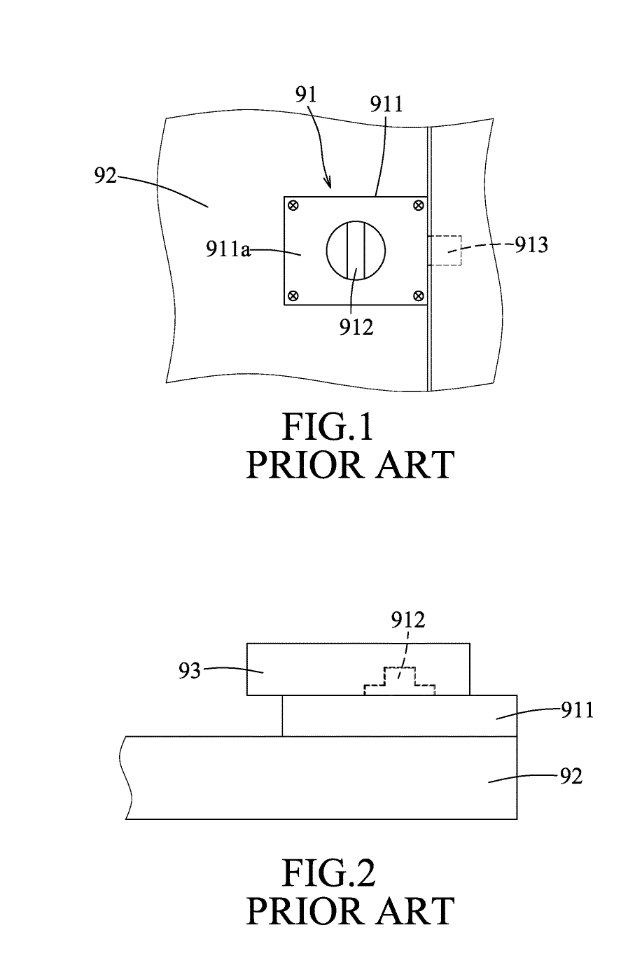

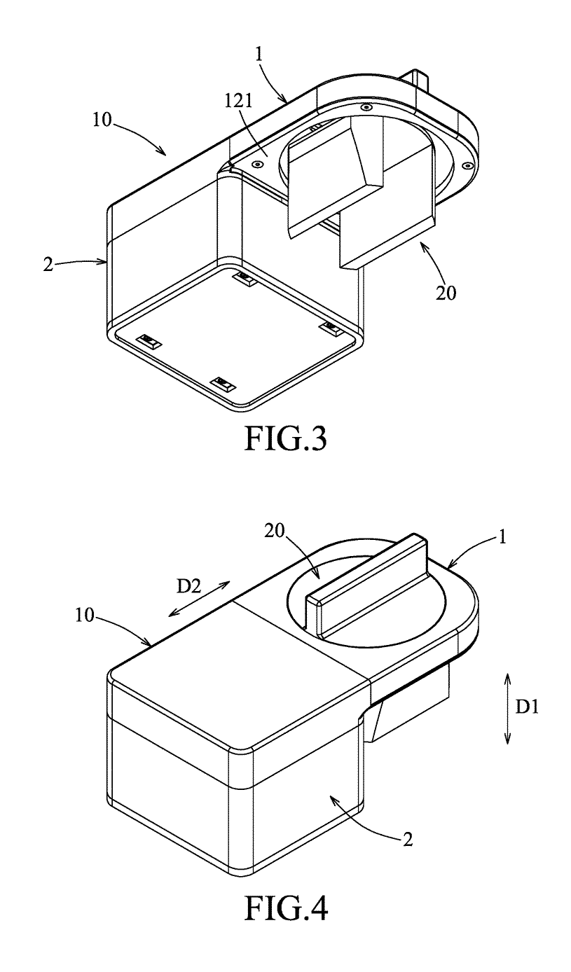

Referring to FIGS. 3 and 4, the first embodiment of the control device according to the disclosure is for operating a door lock 91 that is disposed on a door leaf 92 (see FIGS. 1 and 2). The door lock 91 includes a base seat 911 that is mounted on and protrudes from an outer surface of the door leaf 92, a latch member 913 that is movably mounted to the base seat 911, and a rotary button 912 that is rotatably mounted to and protrudes from an outer surface 911a of the base seat 911 and that is for being rotated to drive movement of the latch member 913 relative to the base seat 911. The first embodiment of the control device includes a casing unit 10 and a control unit 20.

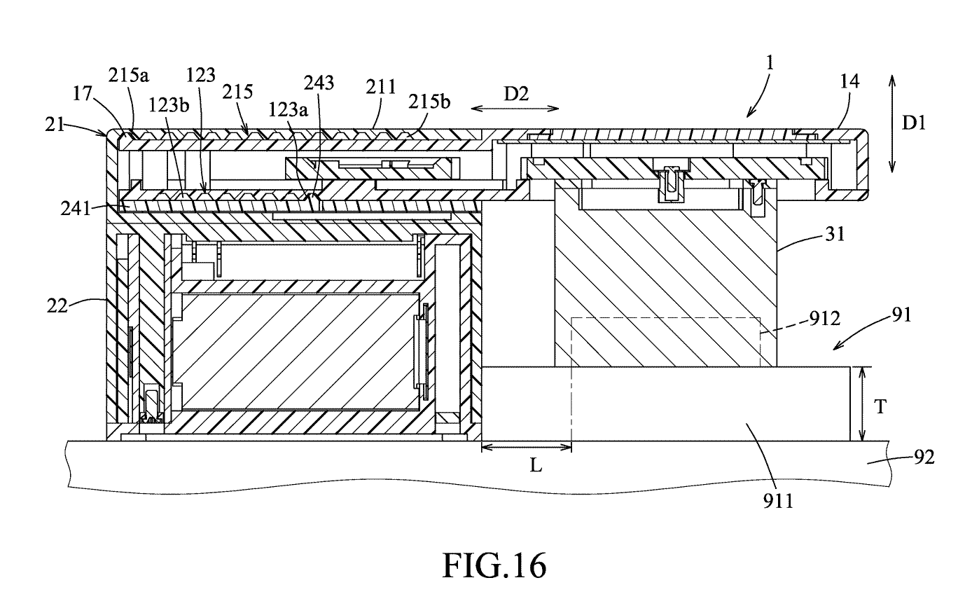

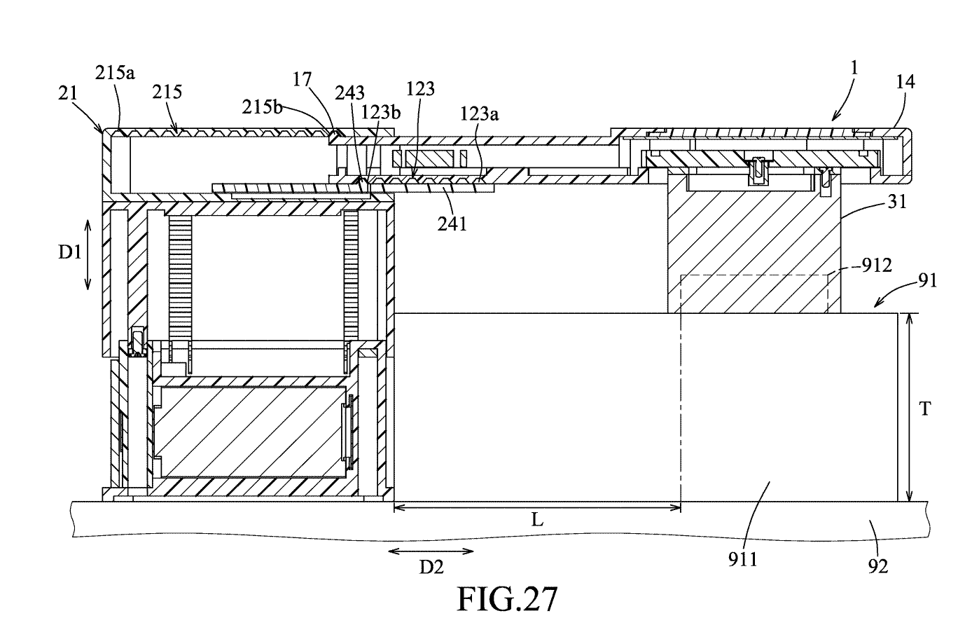

The casing unit 10 includes a carrying module 1 that corresponds in position to the rotary button 912, and a supporting module 2 that is connected to the carrying module 1 and that is mounted to the outer surface of the door leaf 92 (see FIGS. 16 and 27). The carrying module 1 has an inner surface 121 that faces the outer surface 911a of the base seat 911. The supporting module 2 is movable relative to the carrying module 1 in at least one of a first direction (D1) that is perpendicular to the inner surface 121, and a second direction (D2) that is parallel to the inner surface 121. In this embodiment, the supporting module 2 is movable relative to the carrying module 1 in both of the first and second directions (D1, D2).

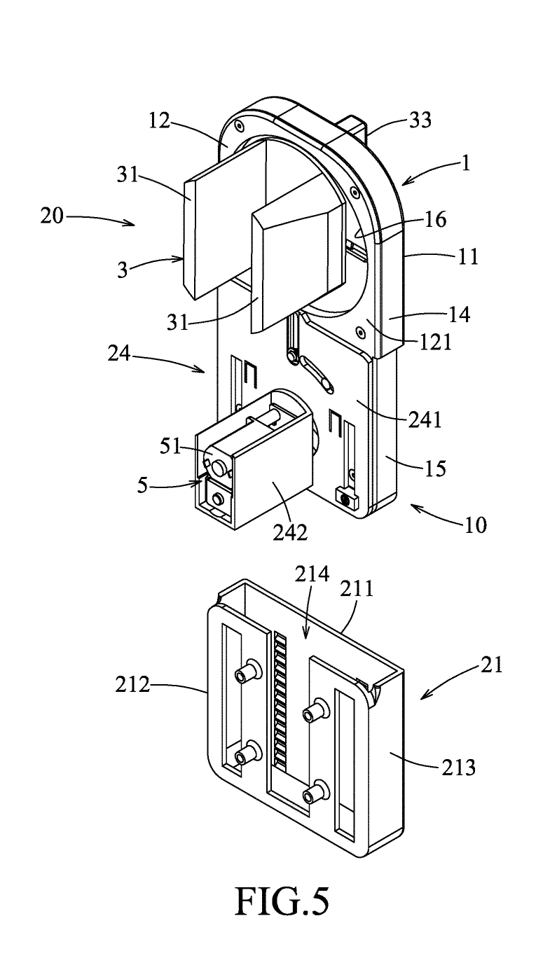

Referring to FIGS. 5 to 7, the carrying module 1 includes a casing seat 11, and a cover plate 12 that has the inner surface 121. The casing seat 11 and the cover plate 12 cooperatively define a retaining space 13, an installation portion 14 and a connecting portion 15. Two widthwise sides of the connecting portion 15 in a widthwise direction that is perpendicular to the first and second directions (D1, D2) are respectively offset inwardly relative to those of the installation portion 14.

The control unit 20 is disposed on the casing unit 10, and includes an operating mechanism 3, a transmission mechanism 4 and a driving mechanism 5. The operating mechanism 3 is mounted to the installation portion 14 of the carrying module 1 and is associated with the rotary button 912 of the door lock 91 for operating the rotary button 912. The installation portion 14 is formed with a through hole 16 for installation of the operating mechanism 3. The transmission mechanism 4 includes a driven gear 41 that is connected to the operating mechanism 3, a driving gear 42 that is connected to the driving mechanism 5, and a plurality of intermediate gears 43 that are disposed between and mesh with the driving gear 42 and the driven gear 41 for transmitting power from the driving gear 42 to the driven gear 41. The transmission mechanism 4 of this embodiment includes two intermediate gears 43 that mesh with each other and that are respectively rotatable about two rotating axles 44. The rotating axles 44 are respectively mounted to two opposite longitudinal ends of a connecting arm 45. A limiting rod 46 is mounted to a middle portion of the connecting arm 45. The cover plate 12 is formed with three gear guide grooves 122. The rotating axles 44 and the limiting rod 46 are respectively movable along the gear guide grooves 122, so that when the supporting module 2 is moved relative to the carrying module 1 in the second direction (D2), the intermediate gears 43 are maintained to transmit power from the driving gear 42 to the driven gear 41.

The driving mechanism 5 includes a motor 51 that has an output shaft connected to the driving gear 42, and receives a wireless signal emitted from a wireless device (e.g., a mobile phone) to actuate the motor 51, so as to rotate the rotary button 912 by virtue of the transmission mechanism 4 and the operating mechanism 3.

The operating mechanism 3 includes two claws 31, a mounting plate 32, an operating member 33 and a connecting member 34. The claws 31 are fixedly mounted to the mounting plate 32, and are spaced part from each other for griping a portion of the rotary button 912 therebetween. The mounting plate 32 is movably mounted to the driven gear 41. The claws 31 mounted on the mounting plate 32 project out of the cover plate 12. The driven gear 41 is formed with a pair of first claw guide grooves 411. The mounting plate 32 is formed with a pair of second claw guide grooves 321 that are perpendicular to the first claw guide grooves 411. The mounting plate 32 is mounted to the driven gear 41 by virtue of two pin assemblies each of which is movable along a respective one of the first claw guide grooves 411 and a respective one of the second claw guide grooves 321, such that the mounting plate 32 and the claws 31 are movable relative to the driven gear 41 for griping the rotary button 912. The operating member 33 is located at one side of the driven gear 41 opposite to the claws 31. The connecting member 34 co-rotatably interconnects the operating member 33 and the driven gear 41. When the control unit 20 is in a manual operation mode, the driven gear 41 is rotated by manually rotating the operating member 33 so as to drive rotation of the mounting plate 32 and the claws 31.

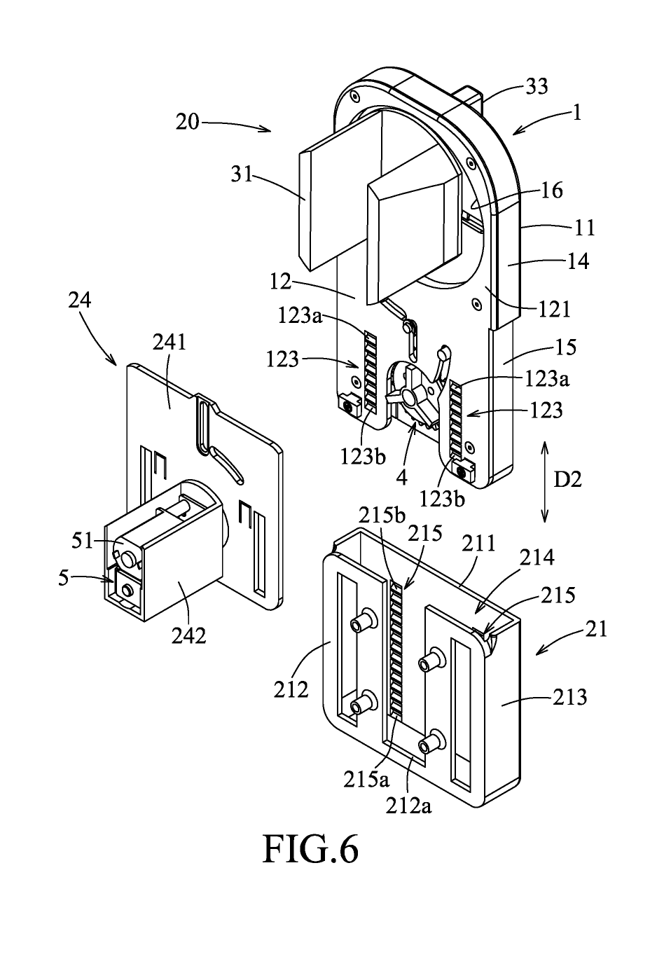

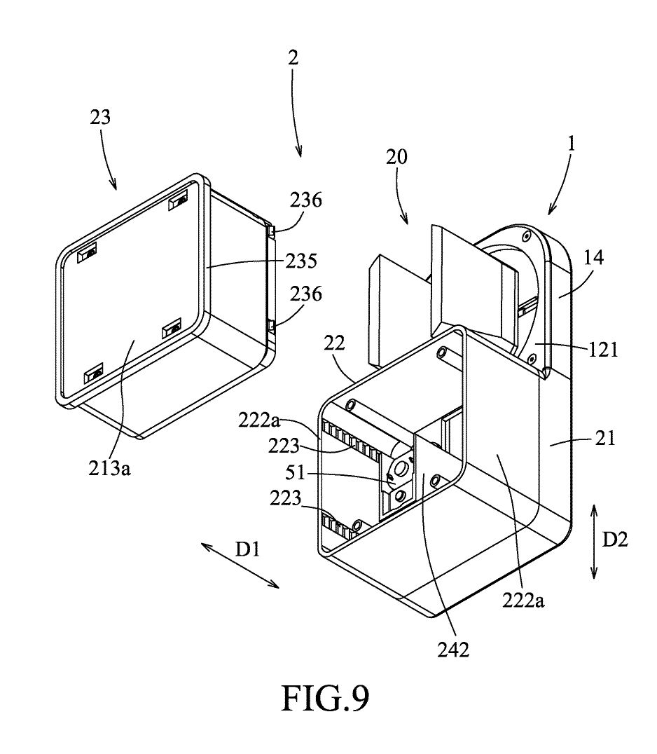

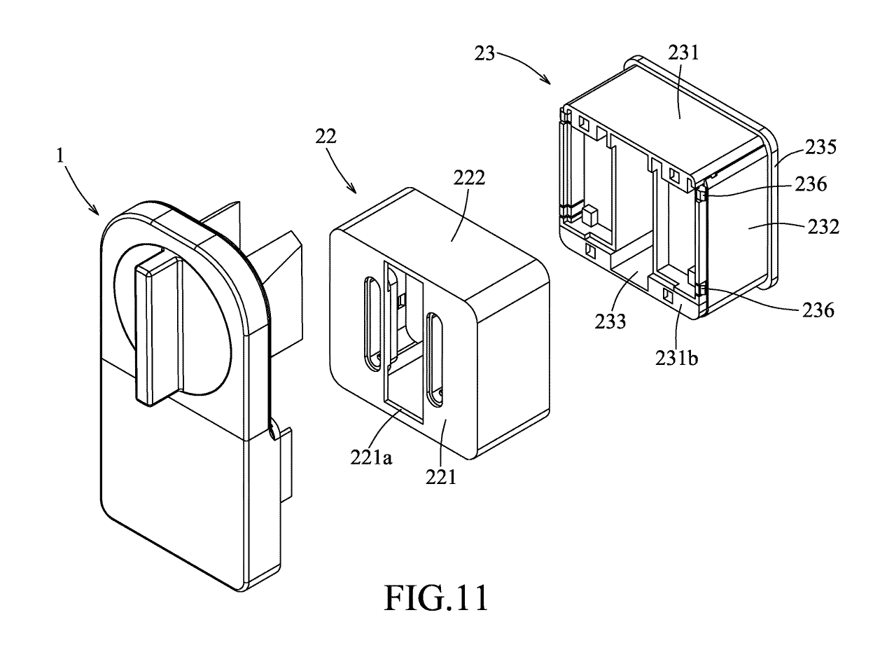

Referring to FIGS. 6 and 9 to 11, the supporting module 2 includes a connecting seat 21, a fixing seat 22, a receiving box 23 and a motor seat 24. The connecting seat 21 is movably sleeved on the connecting portion 15 of the carrying module 1, and is movable relative to the carrying module 1 in the second direction (D2). The connecting seat 21 has a base wall 211, a fixing wall 212 spaced apart from the base wall 211 in the first direction (D1), and a connecting wall 213 connected between the base wall 211 and the fixing wall 212, and cooperating with the base wall 211 and the fixing wall 212 to define a receiving space 214 there among for receiving the connecting portion 15 of the carrying module 1. The base wall 211 is adjacent to the casing seat 11. The fixing wall 212 is adjacent to the cover plate 12.

The fixing seat 22 is fixedly connected to the fixing wall 212 of the connecting seat 21. A distance between the fixing seat 22 and the door leaf 92 is smaller than that between the inner surface 121 of the carrying module 1 and the door leaf 92.

The receiving box 23 is able to be retained in the fixing seat 22, and is movable relative to the fixing seat 22 in the first direction (D1), so that the receiving box 23 is movable relative to the carrying module 1 in the first direction (D1).

The motor seat 24 includes a limiting plate 241 that is disposed between the cover plate 12 and the fixing wall 212 of the connecting seat 21, and a seat body 242 that is fixedly connected to the limiting plate 241 and that projects away from the base wall 211 of the connecting seat 21. The motor 51 is disposed in the seat body 242. The fixing wall 212 of the connecting seat 21 is formed with a first through groove 212a that permits the seat body 242 to movably extend therethrough. The fixing seat 22 has a fixing wall 221, and a surrounding wall 222 that extends from a periphery of the fixing wall 221 away from the connecting seat 21. The fixing wall 221 of the fixing seat 22 is formed with a second through groove 221a that is registered with the first through groove 212a and that permits the seat body 242 to movably extend therethrough.

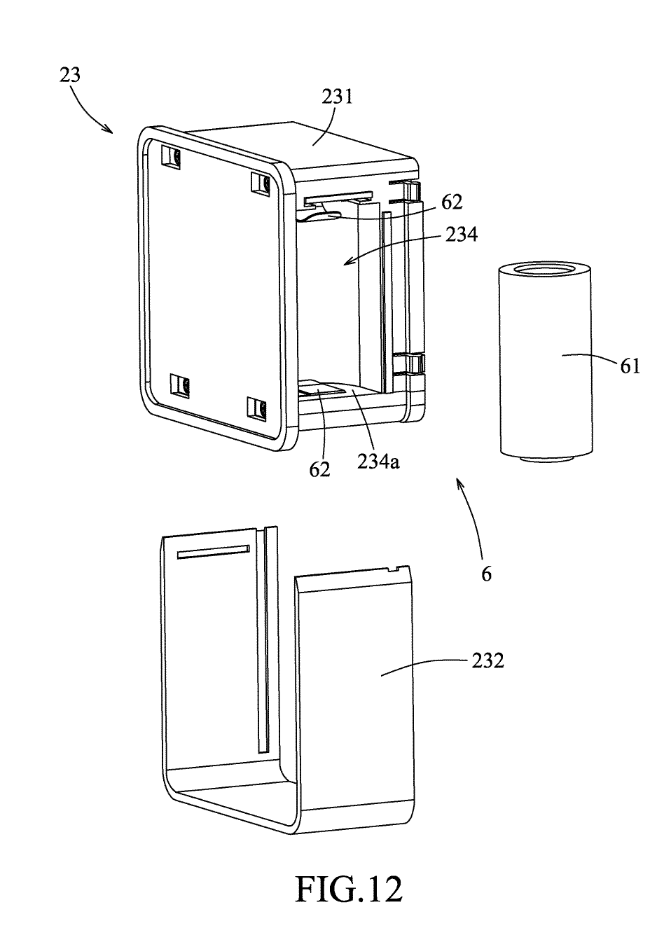

Referring further to FIG. 12, the receiving box 23 includes a box body 231, a cover body 232, a passing space 233 permitting the seat body 242 to move therein, and a power source space 234. The passing space 233 is registered with and in spatial communication with the first through groove 212a and the second through groove 221a, so that the seat body 242 is movable in the second direction (D2) in the passing space 233, the first through groove 212a and the second through groove 221a.

The control unit 20 further includes a power supplying module 6. The power supplying module 6 is disposed in the power source space 234 and is electrically coupled to the driving mechanism 5 for providing electric power to the driving mechanism 5. In this embodiment, the power source space 234 includes two space parts 234a that are respectively located at two opposite lateral sides of the passing space 233 and that open away from each other. The power supplying unit 6 includes two batteries 61 and two pairs of electrode plates 62. The batteries 61 are respectively retained in the space parts 234a of the power source space 234. Each pair of the electrode plates 62 correspond to a respective one of the batteries 61, and is disposed in the corresponding one of the space parts 234a. In this embodiment, the passing space 233 and the power source space 234 are defined by the box body 231. The cover body 232 is U-shaped, and is removably mounted to the box body 231 to cover the space parts 234a of the power source space 234. In renewal of the power supplying module 6, the cover body 232 is first removed from the box body 231 to uncover the space parts 234a, then the batteries 61 are accessible to be replaced before the cover body 232 is mounted back to the box body 231.

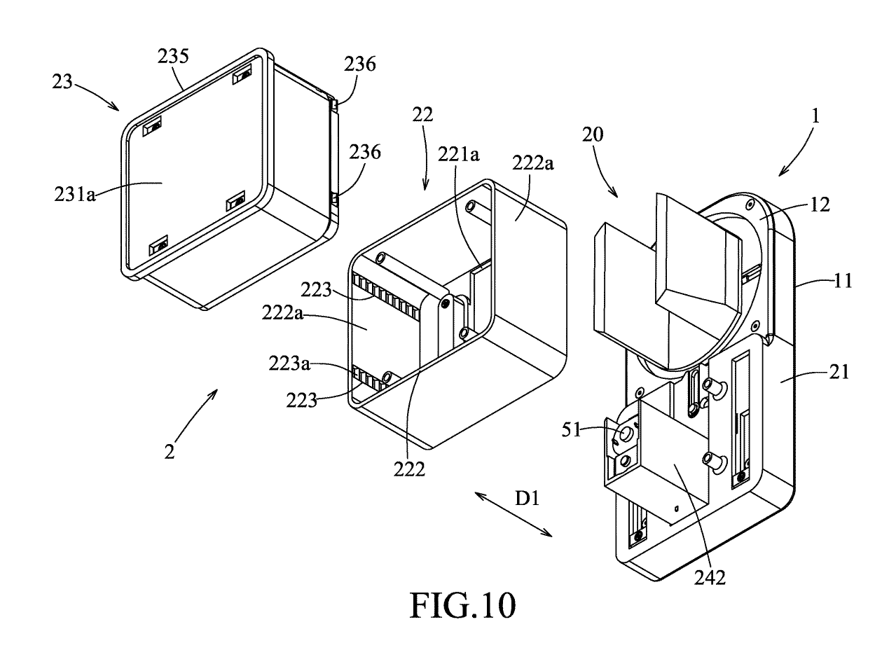

Referring to FIGS. 10, 11 and 13, the surrounding wall 222 of the fixing seat 22 is substantially rectangular, and has two lateral wall segments 222a that are spaced apart from each other in the widthwise direction. An inner surface of each of the lateral wall segments 222a is formed with two box tracks 223 that extend in the first direction (D1). The box tracks 223 of one of the lateral wall segments 222a correspond in position to the box tracks 223 of the other one of the lateral wall segments 222a. The receiving box 23 further has a flange portion 235 that is distal from the connecting seat 21 and that surrounds the box body 231, and a plurality of box positioning structures 236 that are disposed at two lateral sides of the box body 231. The box body 231 has a distal side 231a that is distal from the connecting seat 21, and a proximal side 231b that is proximate to the connecting seat 21. The flange portion 235 is aligned with the surrounding wall 222 of the fixing seat 22 in the first direction (D1), and surrounds the distal side 231a of the box body 231. The receiving box 23 of this embodiment has four box positioning structures 236 that are disposed at two lateral sides of the proximal side 231b of the box body 231, and that are respectively movable along the box tracks 223 of the lateral wall segments 222a. In this embodiment, each of the box tracks 223 consists of a plurality of engaging grooves 223a that are disposed in the first direction (D1). Each of the box positioning structures 236 is configured as a resilient arm, and removably engages one of the engaging grooves 223a of the corresponding one of the box tracks 223. The receiving box 23 is movable relative to the fixing seat 22 in the first direction (D1), and can be positioned relative to the fixing seat 22 at different positions by virtue of the box tracks 223 and the box positioning structures 236.

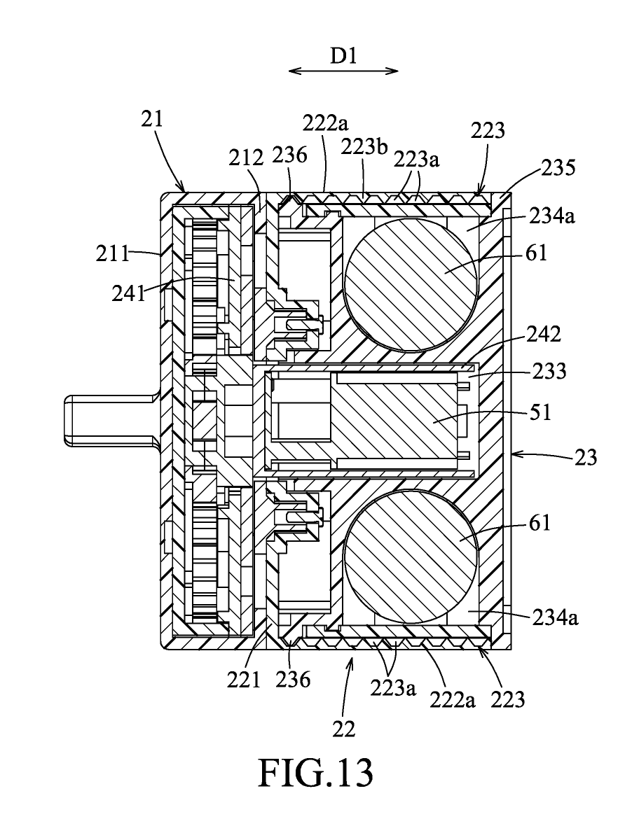

Referring to FIG. 13, when the receiving box 23 projects out of the fixing seat 22 by a minimum extent, each of the box positioning structures 236 is located at an end of the corresponding one of the box tracks 223 proximate to the fixing wall 221 of the fixing seat 22 (i.e., the engaging groove 223a of the corresponding box track 223 that is closest to the fixing wall 221). When the receiving box 23 is drawn out from the fixing seat 22, each of the box positioning structures 236 is pushed by the inner surface of the corresponding lateral wall segment 222a to move past a partition wall portion 223b located between two adjacent ones of the engaging grooves 223a of the corresponding box track 223 to engage the adjacent engaging groove 223a. By such, the receiving box 23 can be positioned relative to the fixing seat 22 after a distance between the fixing seat 22 and the flange portion 235 of the receiving box 23 is adjusted.

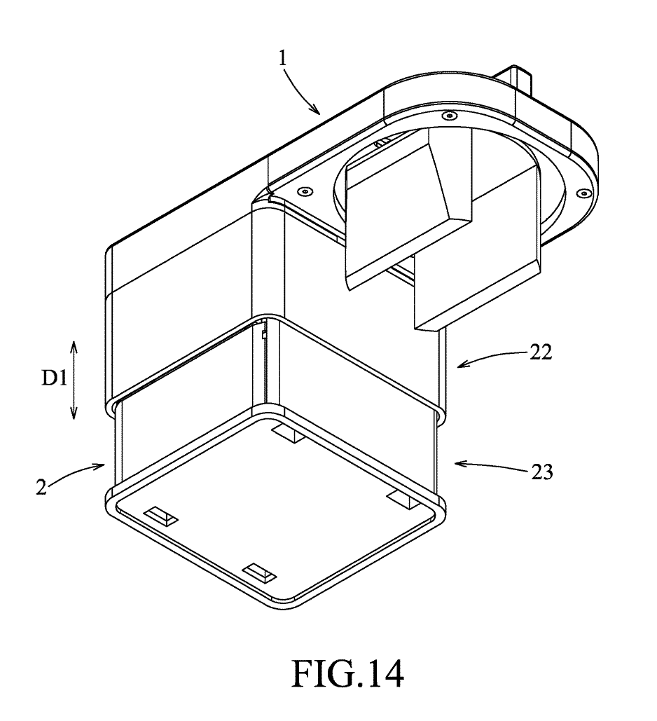

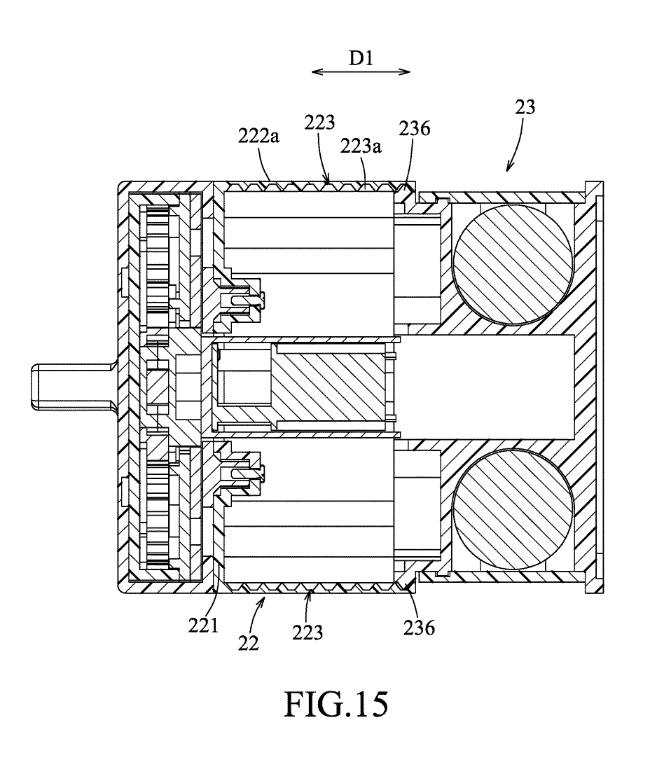

Referring to FIGS. 14 and 15, when the receiving box 23 extends out of the fixing seat 22 by a maximum extent, each of the box positioning structures 236 is located at another end of the corresponding box track 223 distal from the fixing wall 221 of the fixing seat 22 (i.e., the engaging groove 223a of the corresponding box track 223 that is farthest from the fixing wall 221). In this embodiment, each of the lateral wall segments 222a is formed with two box tracks 223. It should be noted that, in a variation, each of the lateral wall segments 222a may be formed with only one box track 223, and the receiving box 23 has two box positioning structures 236 that are respectively movable along the box tracks 223 of the lateral wall segments 222a.

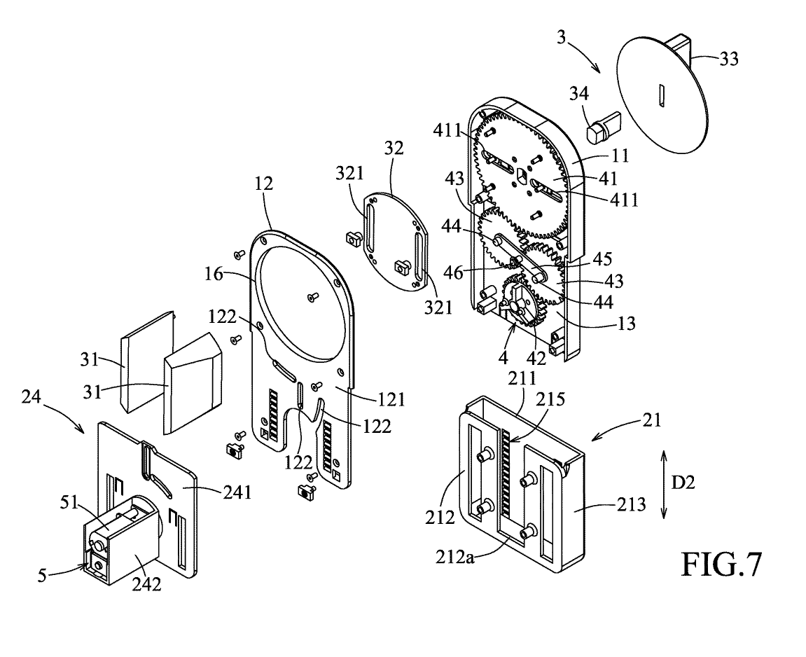

Referring to FIGS. 7, 8 and 16, the carrying module 1 further includes two seat positioning structures 17 that are disposed on a portion of the casing seat 11 partly defining the connecting portion 15 and that are distal from the installation portion 14. An inner surface of the base wall 211 of the connecting seat 21 is formed with two seat tracks 215 that extend in the second direction (D2) and that respectively correspond to the seat positioning structures 17. Each of the seat positioning structures 17 is movable along the corresponding seat track 215. Each of the seat tracks 215 has a first end 215a that is distal from the installation portion 14, and a second end 215b that is proximate to the installation portion 14. The motor seat 24 further includes two plate positioning structures 243 that are disposed on the limiting plate 241. The carrying module 1 further includes two plate tracks 123 that are from in a portion of the cover plate 12 partly defining the connecting portion 15, that extend in the second direction (D2), and that respectively correspond to the plate positioning structures 243. Each of the plate tracks 123 has a first end 123a that is proximate to the installation portion 14, and a second end 123b that is distal from the installation portion 14. In this embodiment, each of the seat tracks 215 and the plate tracks 123 consists of a plurality of engaging grooves that are disposed in the second direction (D2), and each of the seat positioning structures 17 and the plate positioning structures 243 is configured as a resilient arm. The cooperation among the seat tracks 215 and the seat positioning structures 17 and the cooperation among the plate tracks 123 and the plate positioning structures 243 are similar to that among the box tracks 223 and the box positioning structures 236, and would not be further described. Since each of the seat positioning structures 17 removably engages one of the engaging grooves of the corresponding seat track 215 and since each of the plate positioning structures 243 removably engages one of the engaging grooves of the corresponding plate track 123, the connecting seat 21 is movable relative to the carrying module 1 in the second direction (D2), and can be positioned relative to the carrying module 1 at different positions, and the motor seat 24 is movable relative to the carrying module 1 in the second direction (D2), and can be positioned relative to the carrying module 1 at different positions. In this embodiment, the base wall 211 of the connecting seat 21 is formed with two seat tracks 215. It should be noted that, in a variation, the base wall 211 may be formed with only one seat track 215, and the carrying module 1 includes only one seat positioning structure 17 that is movable along the seat track 215 of the base wall 211.

Referring to FIG. 16, when the connecting portion 15 of the carrying module 1 projects out of the connecting seat 21 by a minimum extent and when the limiting plate 241 of the motor seat 24 projects out of the connecting seat 21 by a minimum extent, each of the seat positioning structures 17 is located at the first end 215a of the corresponding seat track 215, and each of the plate positioning structures 243 is located at the first end 123a of the corresponding plate track 123. At this time, the limiting plate 241 of the motor seat 24 is registered with the fixing seat 22 in the first direction (D1).

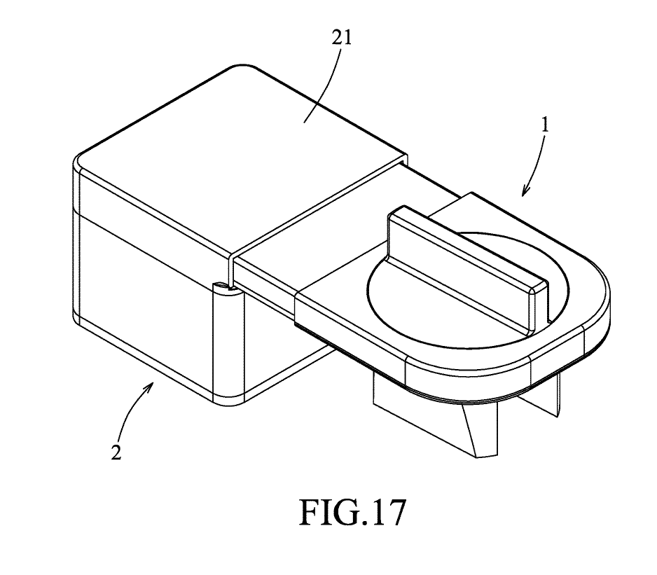

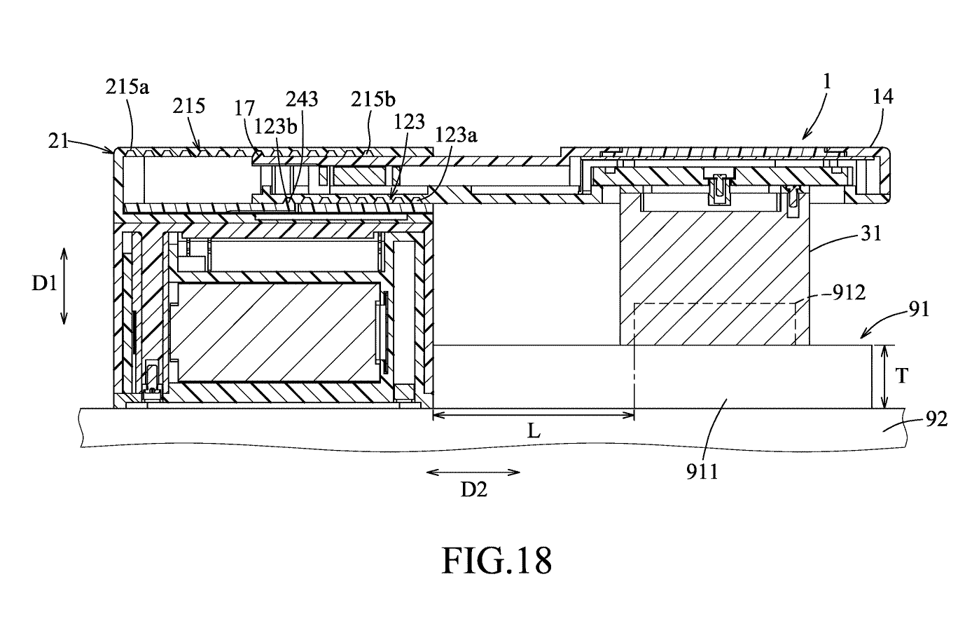

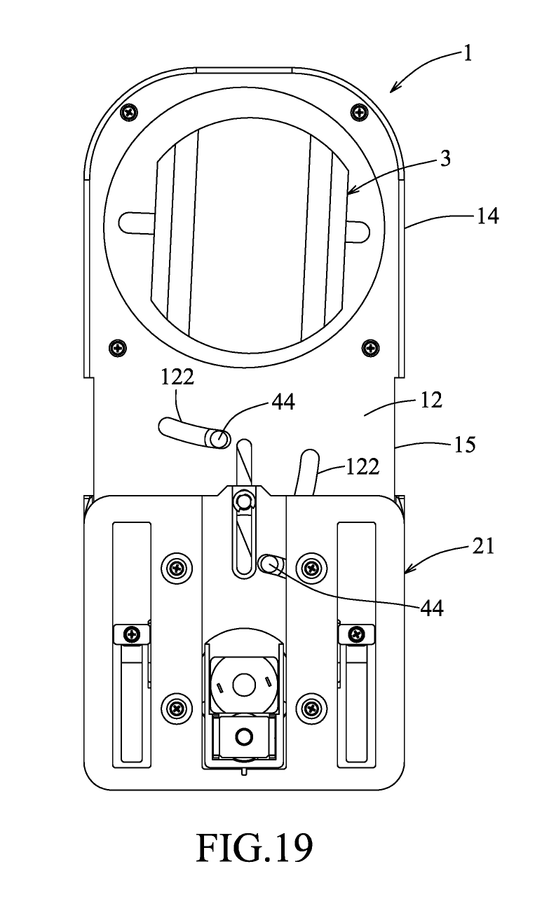

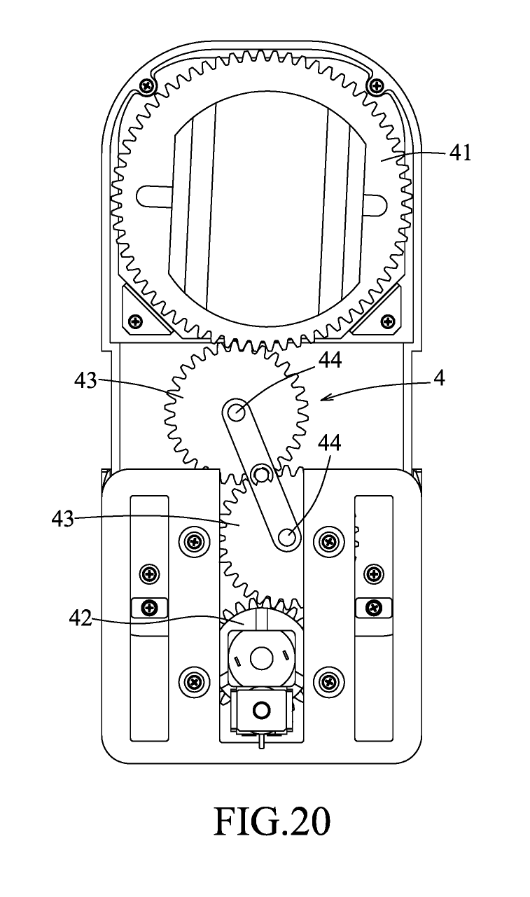

Referring to FIGS. 17 to 20, when the connecting portion 15 of the carrying module 1 is drawn out from the connecting seat 21, each of the seat positioning structures 17 moves along the corresponding seat track 215 toward the second end 215b, and each of the plate positioning structures 243 moves along the corresponding plate track 123 toward the second end 123b. During the abovementioned movement, the motor seat 24 is not moved relative to the connecting seat 21 until each of the plate positioning structures 243 moves to the second end 123b of the corresponding plate track 123 (see FIG. 18), so that a distance between the driving gear 42 and the driven gear 41 is increased. The rotating axles 44 and the limiting rod 46 are respectively movable along the gear guide grooves 122 to rotate the connecting arm 45 so as to maintain the intermediate gears 43 to transmit power from the driving gear 42 to the driven gear 41 (see FIGS. 19 and 20). In this embodiment, each of the seat tracks 215 has a length greater than that of each of the plate tracks 123, so that when each of the plate positioning structures 243 moves to the second end 123b of the corresponding plate track 123, each of the seat positioning structures 17 moves to a position located between the first and second ends 215a, 215b of the corresponding seat track 215.

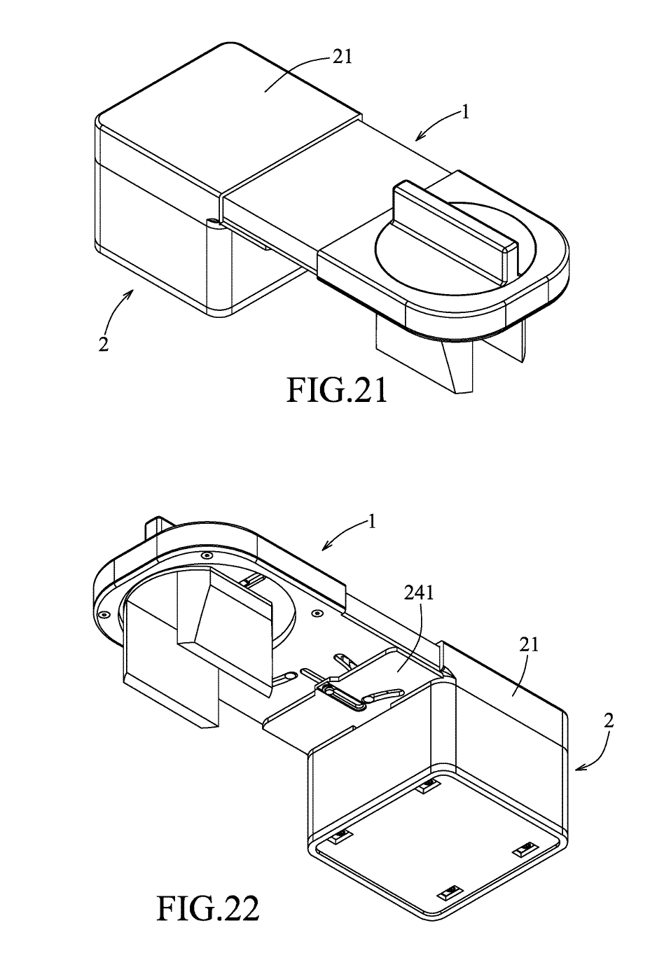

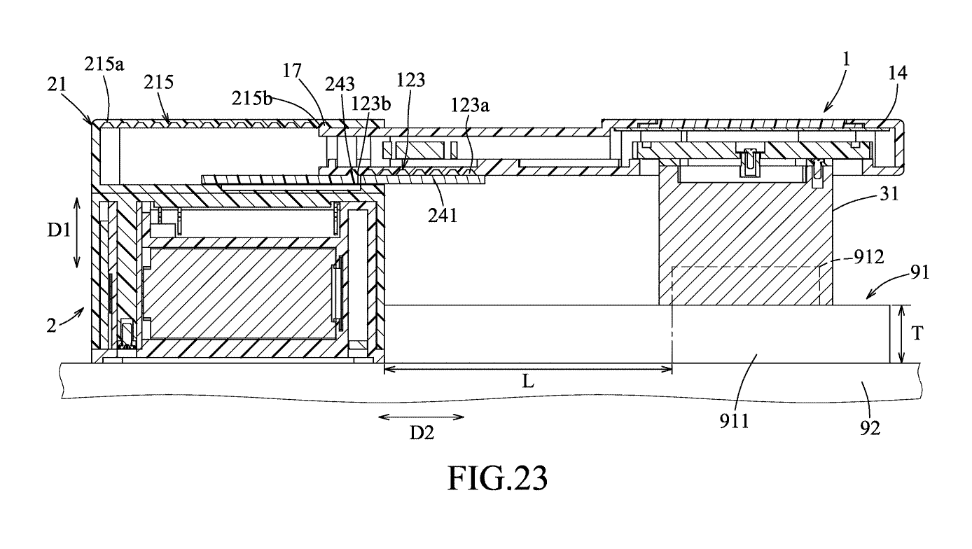

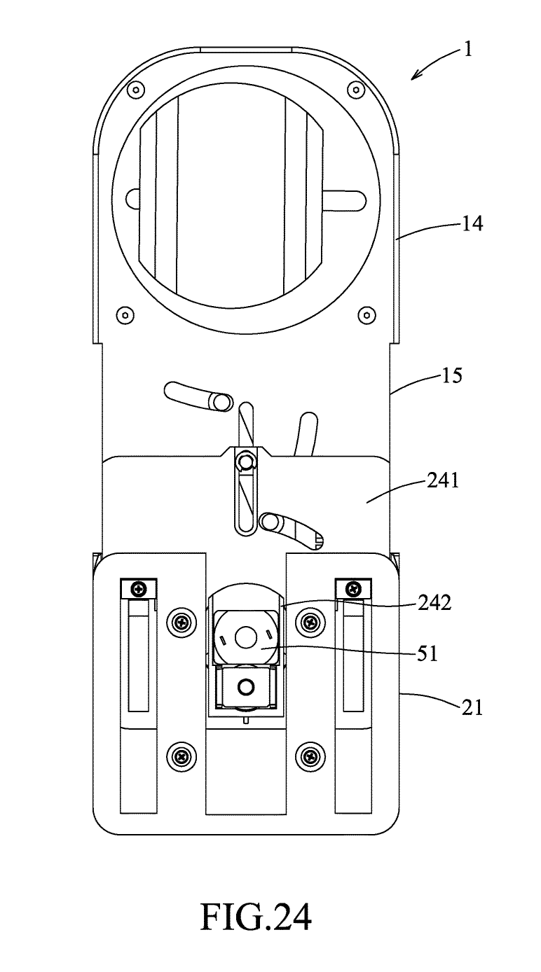

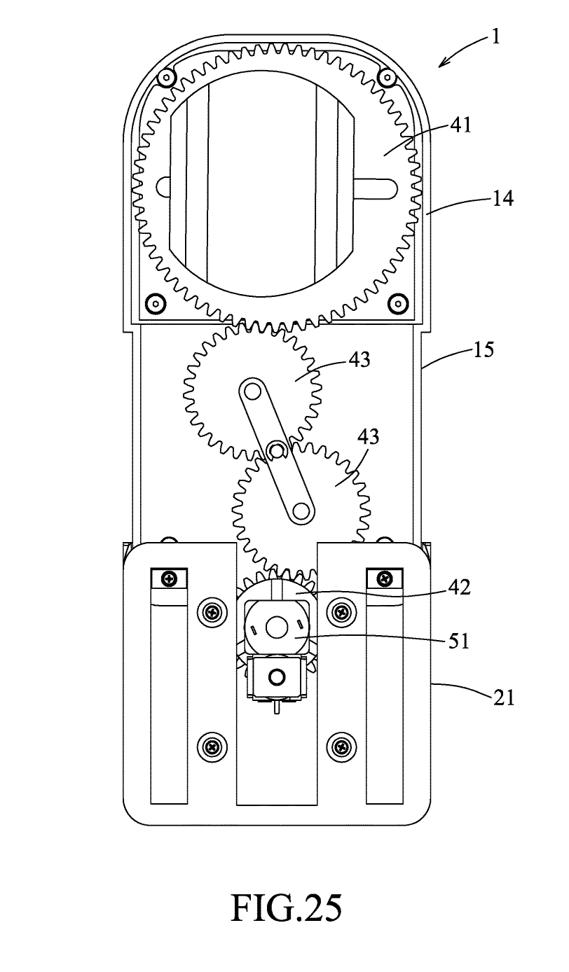

Referring to FIGS. 21 to 23, when the connecting portion 15 of the carrying module 1 is further drawn out from the connecting seat 21 after each of the plate positioning structures 243 moves to the second end 123b of the corresponding plate track 123, the limiting plate 421 of the motor seat 24 can be drawn out from the connecting seat 21 by virtue of the engagement among the plate positioning structures 243 and the second ends 123b of the plate tracks 123 until each of the seat positioning structures 17 moves to the second end 215b of the corresponding seat track 215, whereat the connecting portion 15 of the carrying module 1 projects out of the connecting seat 21 by a maximum extent. Referring to FIGS. 24 and 25, during the abovementioned movement, the distance between the driving gear 42 and the driven gear 41 is maintained constant.

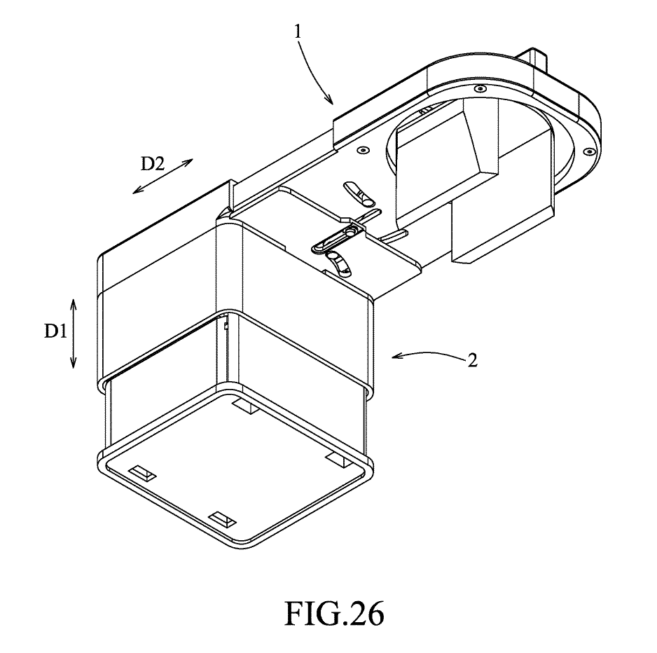

In this embodiment, the supporting module 2 is movable relative to the carrying module 1 in both of the first and second directions (D1, D2). Referring to FIGS. 26 and 27, the connecting portion 15 of the carrying module 1 is shown to project out of the connecting seat 21 by a maximum extent, and the receiving box 23 is shown to project out of the fixing seat 22 by a maximum extent.

Referring to FIGS. 16, 18, 23 and 27, the extent by which the receiving box 23 projects out of the fixing seat 22 can be adjusted according to the thickness (T, see FIGS. 16 and 27) of the base seat 911 of the door lock 91 such that the receiving box 23 steadily abuts against the door leaf 92, and the extent by which the connecting portion 15 of the carrying module 1 projects out of the connecting seat 21 can be adjusted according to a distance (L, see FIGS. 16 and 27) between the rotary button 912 and an edge of the base seat 911 such that the receiving box 23 steadily abuts against the base seat 911.

In summary, the extent by which the receiving box 23 projects out of the fixing seat 22 can be adjusted such that the receiving box 23 steadily abuts against the door leaf 92, and the extent by which the connecting portion 15 of the carrying module 1 projects out of the connecting seat 21 can be adjusted such that the receiving box 23 steadily abuts against the base seat 911. As a result, the receiving box 23 is steadily mounted on the door leaf 92, and the operating mechanism 3 steadily grips the rotary button 812, so that the control device according to the disclosure is suitable for various kinds of door locks.

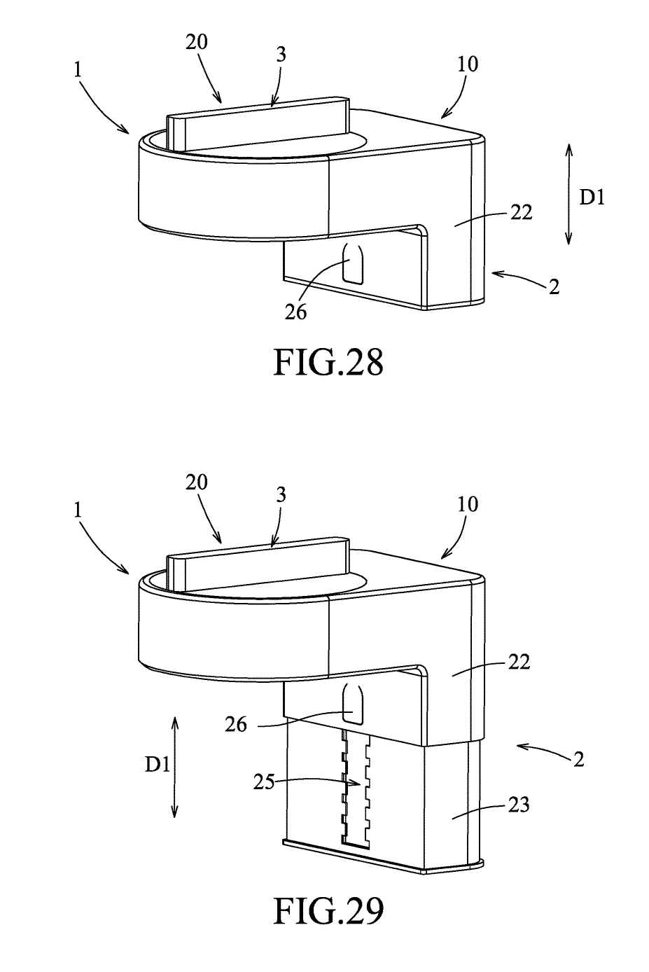

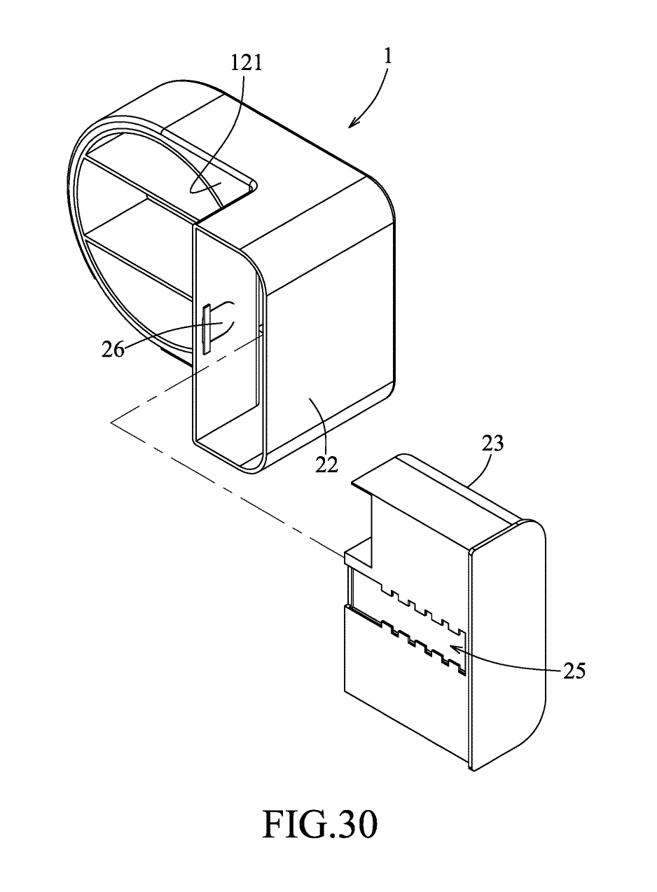

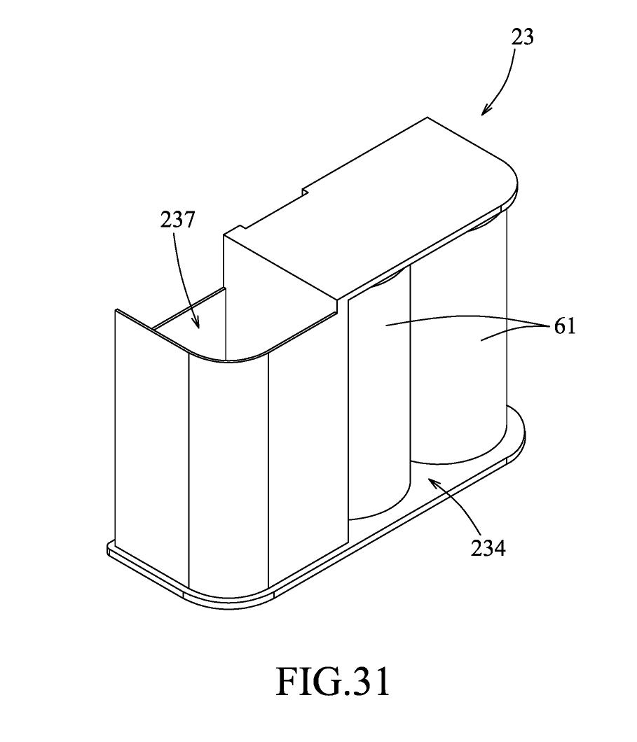

Referring to FIGS. 28 to 31, the second embodiment of the control device according to the disclosure is for operating a door lock 91 disposed on a door leaf 92 (see FIGS. 1 and 2). The door lock 91 includes a base seat 911 that is mounted on and protrudes from an outer surface of the door leaf 92, a latch member 913 that is movably mounted to the base seat 911, and a rotary button 912 that is rotatably mounted to and protrudes from an outer surface 911a of the base seat 911 and that is for being rotated to drive movement of the latch member 913 relative to the base seat 911. The second embodiment of the control device includes a casing unit 10 and a control unit 20.

The casing unit 10 includes a carrying module 1 that corresponds in position to the rotary button 912, and a supporting module 2 that is connected to the carrying module 1 and that is for being mounted to the outer surface of the door leaf 92. The carrying module 1 has an inner surface 121 that faces the outer surface 911a of the base seat 911. The supporting module 2 includes a fixing seat 22 and a receiving box 23. The fixing seat 22 and the carrying module 1 are formed as one piece. The receiving box 23 is able to be retained in the fixing seat 22, and is movable relative to the fixing seat 22 in a first direction (D1) that is perpendicular to the inner surface 121, so that an extent by which the receiving box 23 projects out of the fixing seat 22 is adjustable. In this embodiment, the receiving box 23 has a box track 25, and the fixing seat 22 has a box positioning structure 26. The box track 25 consists of a plurality of engaging grooves that are disposed in the first direction (D1). The box positioning structure 26 is configured as a resilient arm, and removably engages one of the engaging grooves of the box track 25 so that the receiving box 23 is movable relative to the fixing seat 22 in the first direction (D1), and can be positioned relative to the fixing seat 22 at different positions.

The control unit 20 includes an operating mechanism 3 that is similar to that of the first embodiment, a driving mechanism that includes a motor (not shown), and a transmission mechanism (not shown) that is for transmitting mechanical power from the motor to the operating mechanism 3. The transmission mechanism and the driving mechanism of the second embodiment function like the transmission mechanism 4 and the driving mechanism 5 of the first embodiment, and can be comprehended by one skilled in the art. The receiving box 23 has a power source space 234 that is for retaining two batteries 61, and a motor space 237 that is for retaining the motor of the control unit 20.

The first embodiment of this disclosure may be modified according to actual demand such that the supporting module 2 is movable relative to the carrying module 1 in only one of the first and second directions (D1, D2).

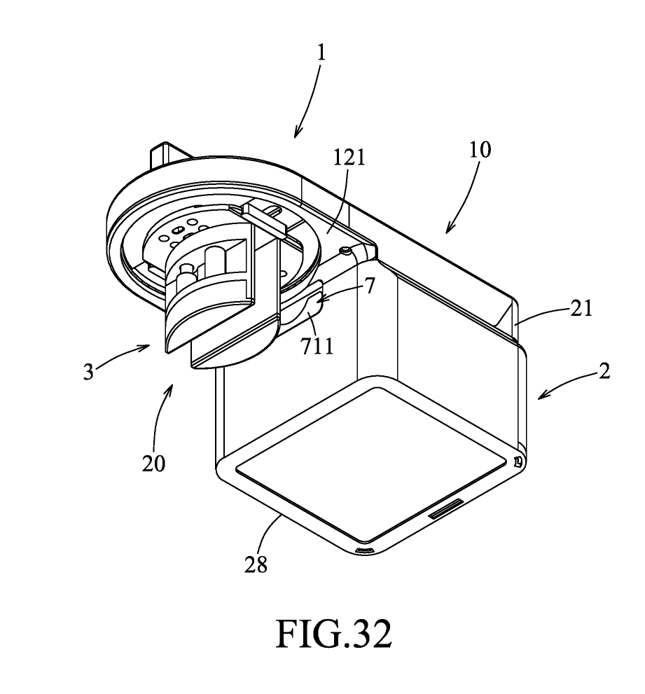

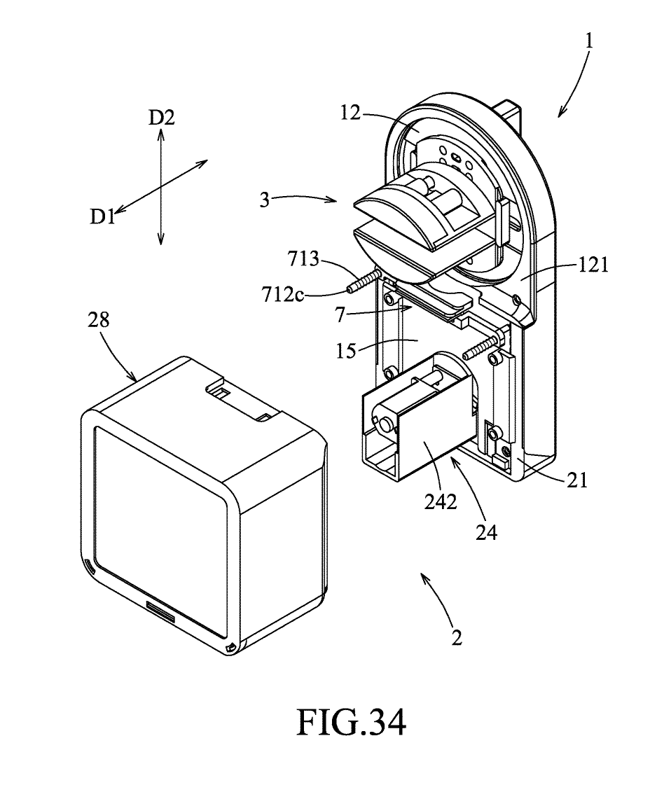

Referring to FIGS. 32 to 34, the third embodiment of the control device according to the disclosure includes a casing unit 10 and a control unit 20. The control unit 20 of the third embodiment is similar to that of the first embodiment, and includes an operating mechanism 3, a transmission mechanism (not labeled), a driving mechanism (not labeled) and a power supplying module (not shown). The casing unit 10 includes a carrying module 1, a supporting module 2 and a latch module 7. The carrying module 1 of the third embodiment is similar to that of the first embodiment. The supporting module 2 includes a connecting seat 21, a fixing seat 27, a cover seat 28 and a motor seat 24. The connecting seat 21 is movably sleeved by the connecting portion 15 of the carrying module 1, and is movable relative to the carrying module 1 in the second direction (D2).

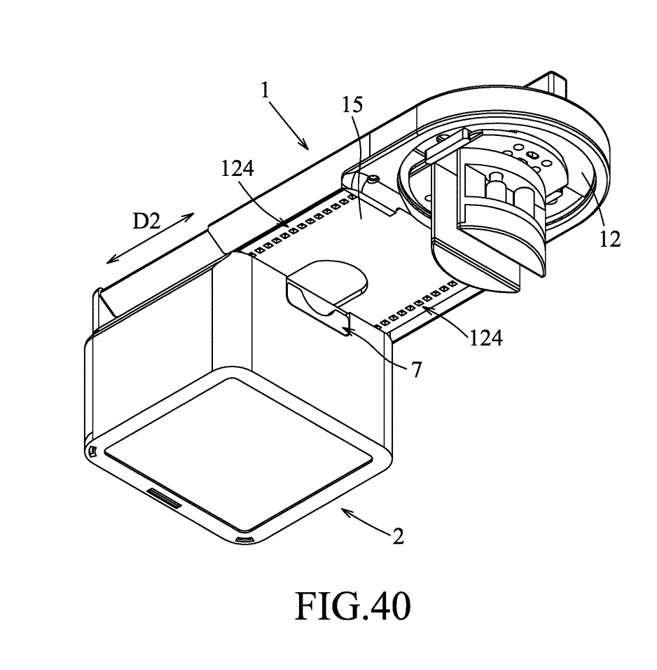

The carrying module 1 further includes two seat tracks 124 (see FIG. 40) that are formed in a portion of the cover plate 12 partly defining the connecting portion 15 and that extend in the second direction (D2). In this embodiment, each of the seat tracks 124 consists of a plurality of engaging grooves that are disposed in the second direction (D2).

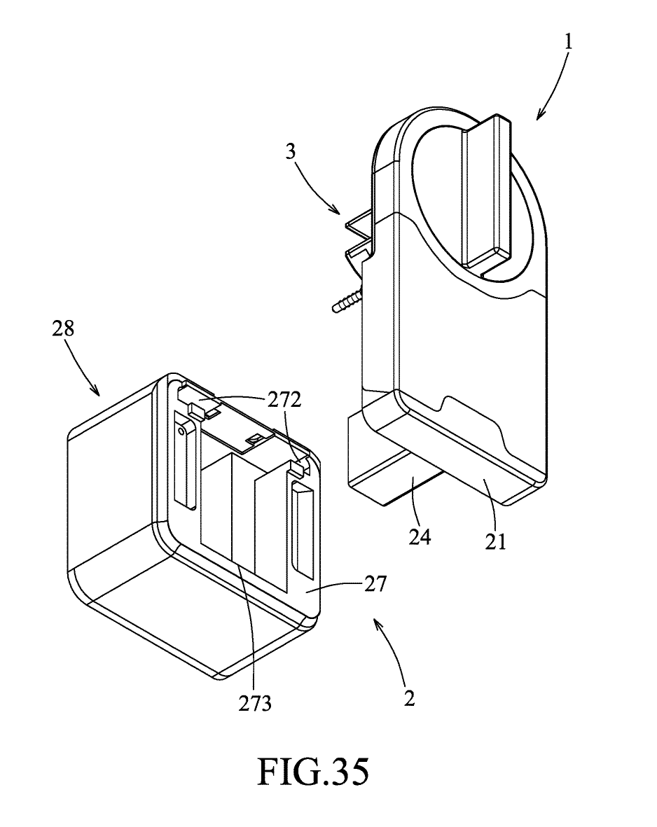

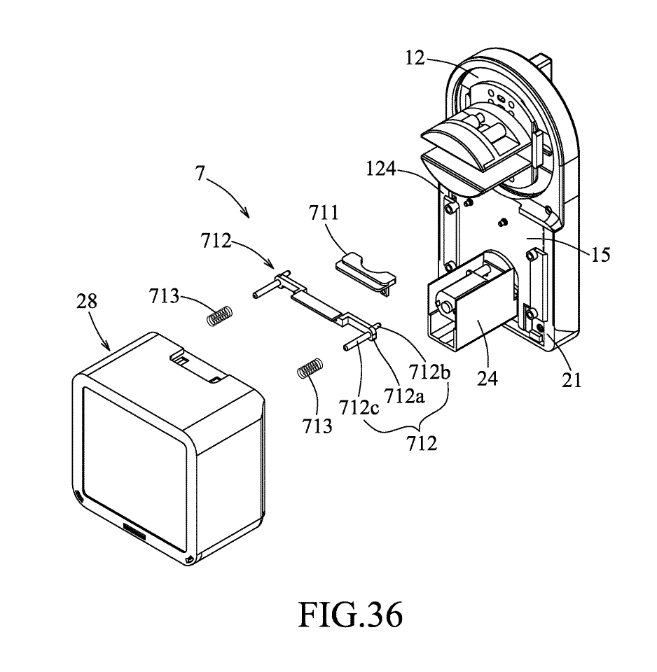

Referring further to FIGS. 35 and 36, the fixing seat 27 is fixedly connected to the connecting seat 21. A distance between the fixing seat 22 and the door leaf 92 is smaller than that between the inner surface 121 of the carrying module 1 and the door leaf 92 (similar to the first embodiment, see FIG. 16).

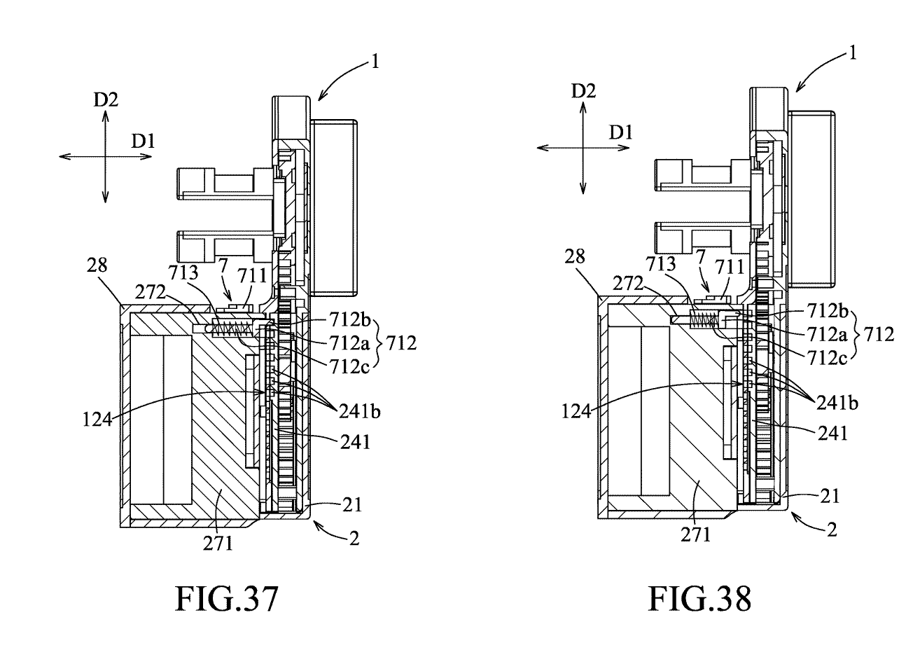

The latch module 7 is disposed on the fixing seat 27, and includes an operating portion 711 that is accessible from the outside of the fixing seat 27 for manual operation, two latch portions 712 that are connected to the operating portion 711 and that respectively correspond to the seat tracks 124, and two resilient members 713. Each of the latch portions 712 has a connecting segment 712a that is connected to the operating portion 711, a latch segment 712b that extends from the connecting segment 712a toward the cover plate 12 in the first direction (D1), and an extending segment 712c that extends from the connecting segment 712a away from the cover plate 12 in the first direction (D1). The fixing seat 27 includes a main body 271, and two recesses 272 (see FIG. 35) that are formed in the main body 271 and that respectively receive the extending segments 712c of the latch portions 712 therein. Each of the latch portions 712 is movable between a locking position (see FIG. 37) where the latch segment 712b thereof engages one of the engaging grooves of the corresponding seat track 124, and an unlocking position (see FIG. 38) where the latch segment 712b thereof is separated from the corresponding seat track 124.

The resilient members 713 are respectively sleeved on the extending segments 712c of the latch portions 712. Each of the resilient members 713 has two opposite ends respectively abutting against the corresponding connecting segment 712a and an inner surface of the main body 271 of the fixing seat 27 for resiliently biasing the latch segments 712b of the latch portions 712 toward the locking position so as to position the carrying module 1 relative to the supporting module 2 in the second direction (D2).

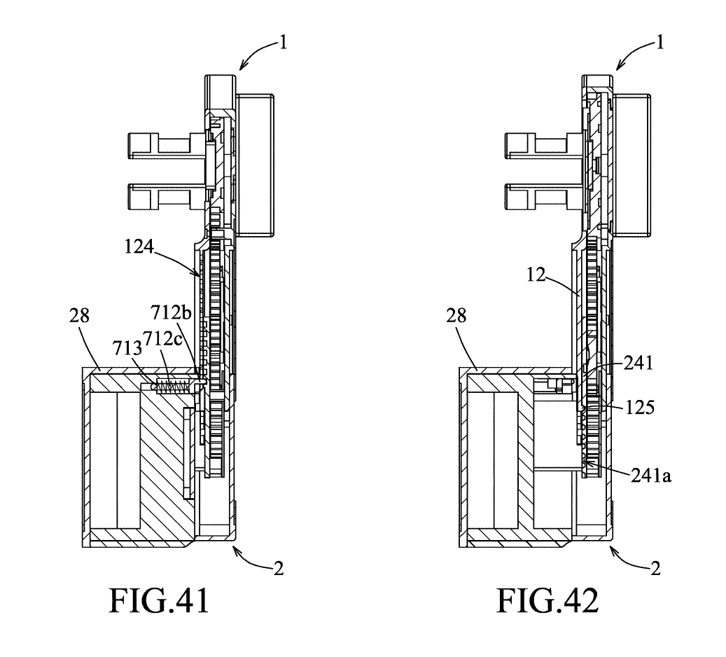

To adjust a distance between the operating mechanism 3 and the supporting module 2, the operating portion 711 of the latch module 7 is first depressed so as to separate the latch segments 712b from the seat tracks 124. Then, the supporting module 2 can be moved relative to the carrying module 1 in the second direction (D2) before the operating portion 711 of the latch module 7 is released so that each of the latch segments 712b engages another engaging groove of the corresponding seat track 124 (see FIG. 41) to position the supporting module 2 relative to the carrying module 1 in the second direction (D2). FIG. 40 illustrates that the supporting module 2 projects relative to the carrying module 1 by a maximum extent.

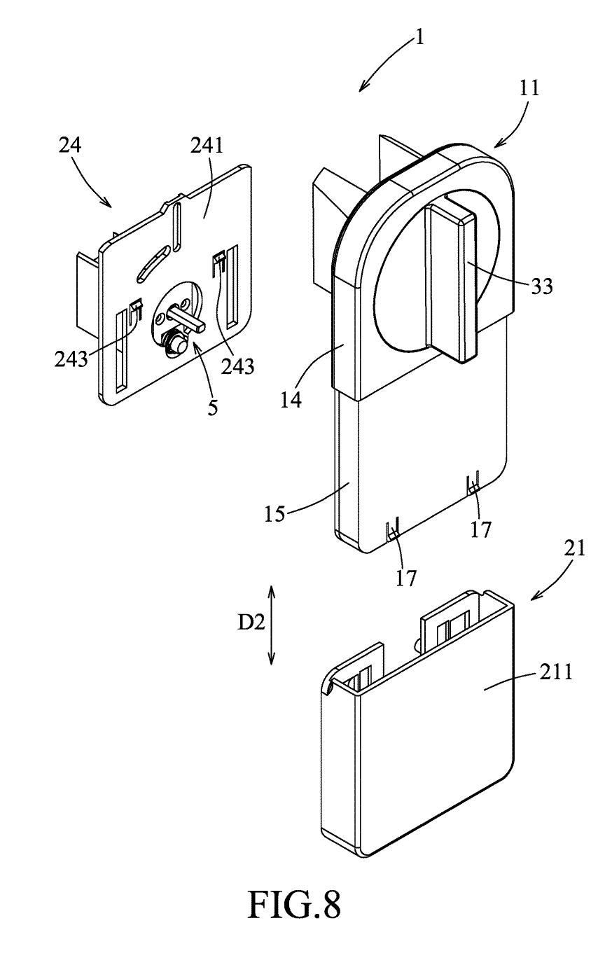

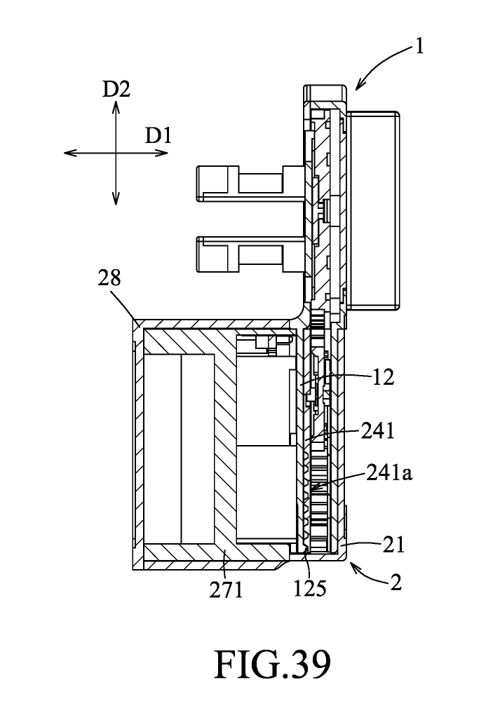

Referring further to FIGS. 39 and 42, in the third embodiment, a limiting plate 241 of the motor seat 24 is disposed at one side of the cover plate 12 opposite to the fixing seat 27, and is partially covered by the cover plate 12. The limiting plate 241 is formed with two plate tracks 241a (only one is visible in FIG. 42). The carrying module 1 further includes two plate positioning structures 125 (only one is visible in FIG. 42) that are disposed on the cover plate 12 and that respectively correspond to the plate tracks 241a. In this embodiment, each of the plate tracks 241a consists of a plurality of engaging grooves that are disposed in the second direction (D2), and each of the plate positioning structures 125 is configured as a resilient arm. The cooperation among the plate tracks 241a and the plate positioning structures 125 is similar to that among the plate tracks 123 and the plate positioning structures 243 of the first embodiment (see FIGS. 6 and 8), and would not be further described. In this embodiment, the limiting plate 241 is further formed with two plate positioning tracks (see FIGS. 37 and 38, only one is visible). Each of the plate positioning tracks corresponds to a respective one of the seat tracks 124, and consists of a plurality of positioning grooves 241b. Each of the latch segments 712b extends through one of the engaging grooves of the corresponding seat track 124 to engage one of the positioning grooves 241b of a corresponding one of the plate positioning tracks, so as to steadily position the limiting plate 241 relative to the cover plate 12.

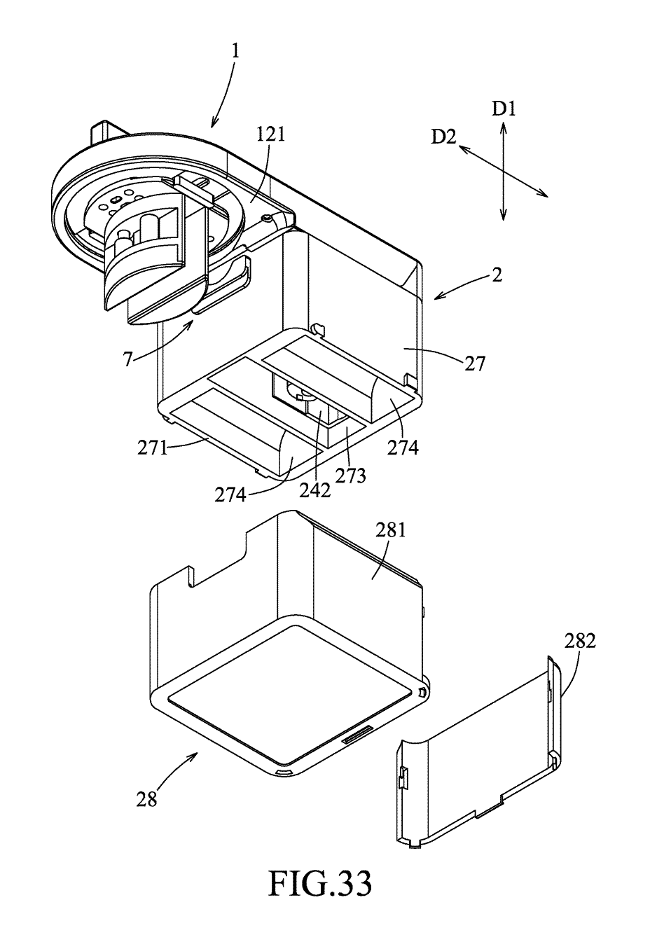

Referring to FIGS. 33 to 36 again, the fixing seat 27 further includes a passing space 273 that is formed through the main body 271 and that permits a seat body 242 of the motor seat 24 to move therein, and at least one power source space 274 that is formed in the main body 271 and that opens away from the connecting seat 21 for retaining the power supplying module (not shown).

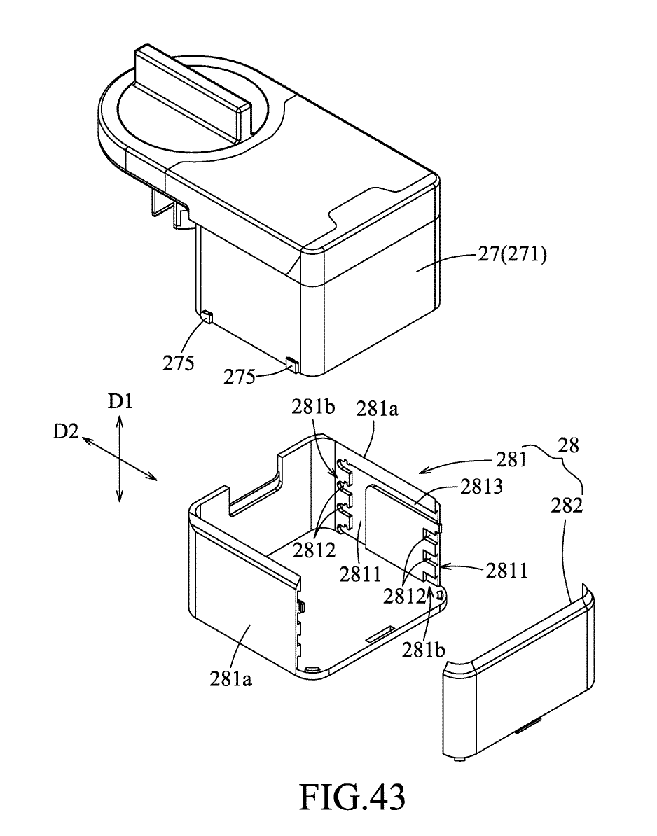

Referring further to FIG. 43, the cover seat 28 is able to receive the fixing seat 27 therein, and includes a main seat 281, and a cap member 282 that is removably mounted to the main seat 281. The main seat 281 has two spaced-apart cover side walls 281a. Each of the cover side walls 281a has at least one cover track 281b that is formed in an inner surface thereof facing toward the other one of the cover side walls 281a, and that extends in the first direction (D1). Each of the cover tracks 281b of the cover side walls 281a consists of a plurality of engaging grooves 2812 that are disposed in the first direction (D1). The fixing seat 27 further includes a plurality of positioning blocks 275 that are disposed on a periphery of the main body 271 and that respectively correspond to the cover tracks 281b of the cover side walls 281a.

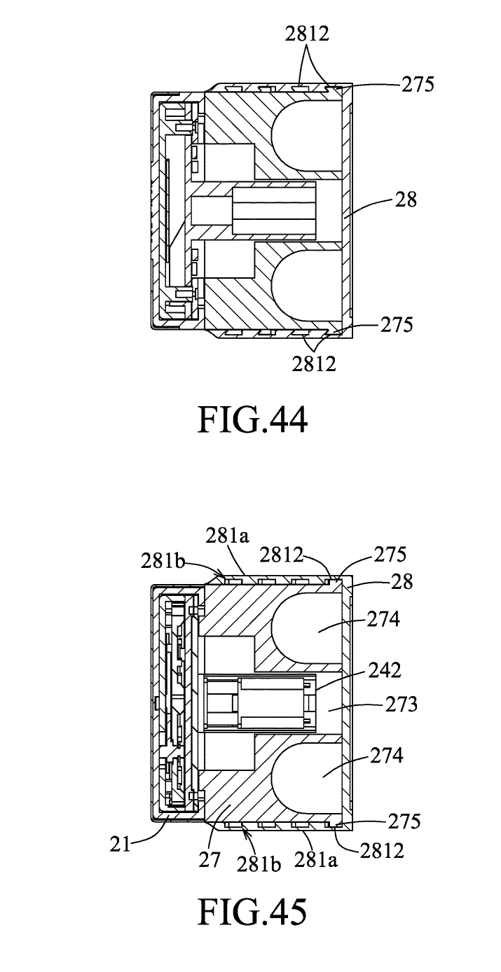

Referring to FIGS. 44 and 45, when the fixing seat 27 projects out of the cover seat 28 by a minimum extent, each of the positioning blocks 275 engages the engaging groove 2812 of the corresponding cover track 281b that is farthest from the connecting seat 21.

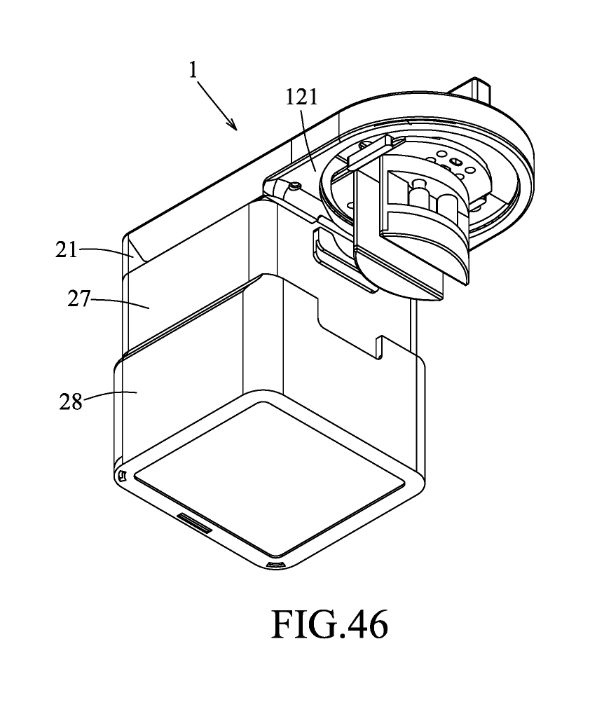

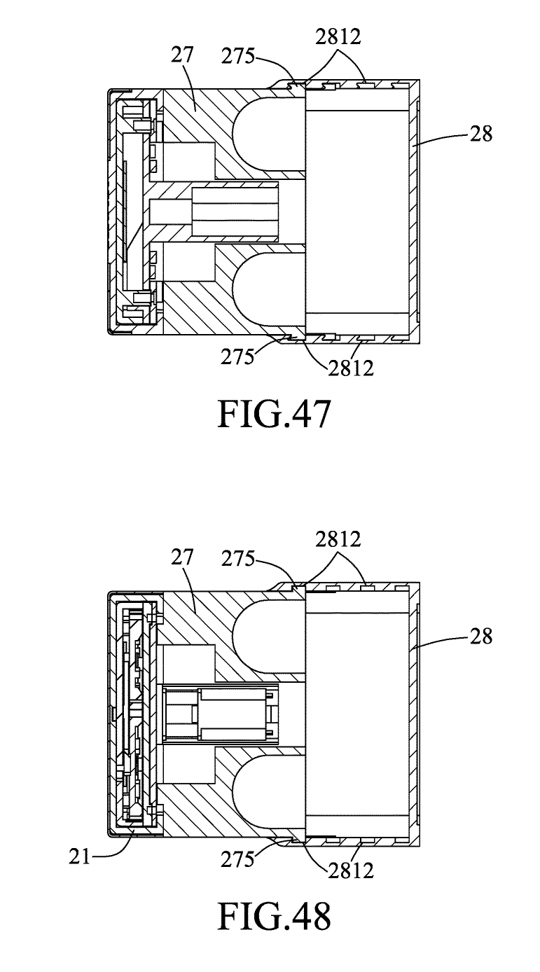

Referring to FIGS. 46 to 48, when the fixing seat 27 projects out of the cover seat 28 by a maximum extent, each of the positioning blocks 275 engages the engaging groove 2812 of the corresponding cover track 281b that is closest to the connecting seat 21.

In this embodiment, the cap member 282 is removably mounted to an end of each of the cover side walls 281a in the second direction (D2). Each of the cover side walls 281a has proximate and distal cover tracks 281b that are spaced apart from each other in the second direction (D2), a communication groove 2811 (see FIG. 43) that extends in the first direction (D1) and that is in spatial communication with the engaging grooves 2812 of the distal cover track 281b distal from the cap member 282, and an entrance groove 2813 that extends in the second direction (D2) and that is in spatial communication with the communication groove 2811 and one of the engaging grooves 2812 of the proximate cover track 281b proximate to the cap member 282. The fixing seat 27 includes two proximate positioning blocks 275 that are disposed on the periphery of the main body 271 and that respectively correspond to the proximate cover tracks 281b of the cover side walls 281a, and two distal positioning blocks 275 that are disposed on the periphery of the main body 271 and that respectively correspond to the distal cover tracks 281b of the cover side walls 281a (only one proximate positioning block 275 and one distal positioning block 275 are visible in FIG. 43). Each of the positioning blocks 275 removably engages one of the engaging grooves 2812 of the corresponding cover track 281b so as to prevent the relative movement between the fixing seat 27 and the cover seat 28 in the first direction (D1). The cover seat 28 abuts against the proximate positioning blocks 275 so as to prevent the relative movement between the fixing seat 27 and the cover seat 28 in the second direction (D2).

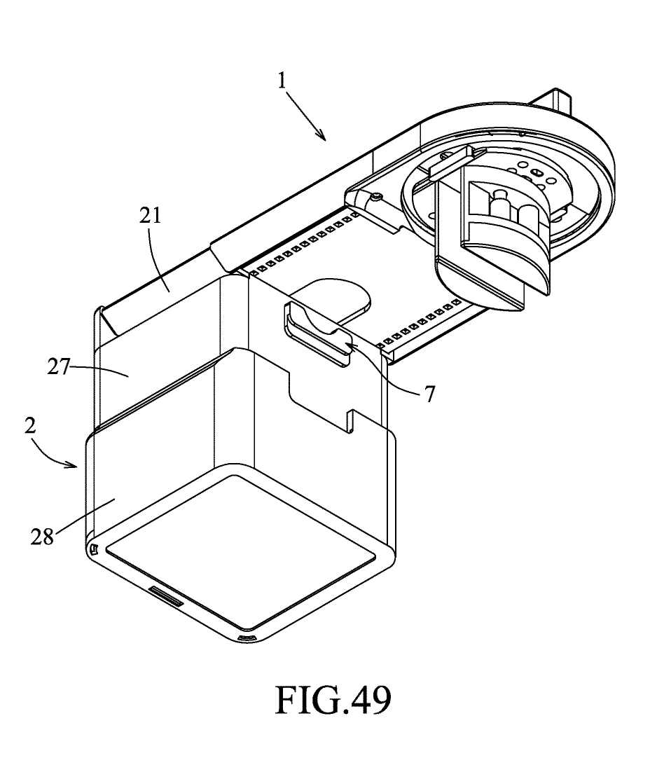

To adjust the extent by which the fixing seat 27 projects out of the cover seat 28, the cap member 282 is first separated from the main seat 281 to permit the relative movement between the fixing seat 27 and the cover seat 28 in the second direction (D2), so that the distal positioning blocks 275 can be respectively moved into the communication grooves 2811 of the cover side walls 281a and the proximate positioning blocks 275 can be respectively disengaged from the proximate cover tracks 281b. Then, the fixing seat 27 is moved relative to the cover seat 28 in the first direction (D1) to adjust the extent by which the fixing seat 27 projects out of the cover seat 28 before the fixing seat 27 is moved relative to the cover seat 28 in the second direction (D2) to engage each of the positioning blocks 275 with another one of the engaging grooves 2812 of the corresponding cover track 281b. Subsequently, the cap member 282 is mounted back to the main seat 281 to prevent the relative movement between the fixing seat 27 and the cover seat 28 in the second direction (D2). FIG. 49 illustrates that the supporting module 2 projects relative to the carrying module 1 by a maximum extent, and the fixing seat 27 projects out of the cover seat 28 by a maximum extent.

Referring to FIGS. 33 and 43, the cover seat 28 covers the passing space 273 and the power source space 274 of the fixing seat 27. In renewal of the power supplying module, the cap member 282 is first separated from the main seat 281 to permit the relative movement between the fixing seat 27 and the cover seat 28 in the second direction (D2), so that the distal positioning blocks 275 can be respectively moved into the communication grooves 2811 of the cover side walls 281a. Then, the fixing seat 27 is moved relative to the cover seat 28 in the first direction (D1) to respectively align the distal positioning blocks 275 with the entrance grooves 2813 of the cover side walls 281a. Subsequently, the fixing seat 27 is moved relative to the cover seat 28 in the second direction (D2) to respectively move the distal positioning blocks 275 along the entrance grooves 2813 until the fixing seat 27 is separated from the main seat 281, such that the power source space 274 is accessible for replacement of the power supplying module before the cover seat 28 is mounted back to the fixing seat 27.

The advantages of the third embodiment are the same as those of the first embodiment.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A control device adapted for operating a door lock that is disposed on a door leaf, the door lock including a base seat that is mounted on and protrudes from an outer surface of the door leaf, and a rotary button that is rotatably mounted to and protrudes from an outer surface of the base seat, said control device comprising:
a casing unit including a carrying module that corresponds in position to the rotary button, and a supporting module that is connected to said carrying module and that is adapted to be mounted to the outer surface of the door leaf, said carrying module having an inner surface that faces the outer surface of the base seat, said supporting module being movable relative to said carrying module in at least one of a first direction that is perpendicular to said inner surface, and a second direction that is parallel to said inner surface; and
a control unit disposed on the casing unit, and including an operating mechanism, a transmission mechanism and a driving mechanism, said operating mechanism being mounted to said carrying module and associated with the rotary button of the door lock for operating the rotary button, said transmission mechanism being associated with said operating mechanism, said driving mechanism being associated with said transmission mechanism, and being capable of receiving a wireless signal to actuate said operating mechanism via said transmission mechanism, so as to operate the rotary button.

2. The control device as claimed in claim 1, wherein said supporting module includes a receiving box, said receiving box being movable relative to said carrying module in the first direction for adjusting a distance between said inner surface of said carrying module and the outer surface (911a) of the base seat.

3. The control device as claimed in claim 2, wherein said supporting module further includes a fixing seat, said fixing seat being positioned relative to said carrying module in the first direction and being capable of receiving at least a portion of said receiving box, said receiving box being movable relative to said fixing seat in the first direction.

4. The control device as claimed in claim 3, wherein said fixing seat has two lateral wall segments that are spaced apart from each other, each of said lateral wall segments being formed with at least one box track that extends in the first direction, said receiving box having a box body, and a plurality of box positioning structures that are disposed at two lateral sides of said box body, said box positioning structures respectively corresponding to said box tracks of said lateral wall segments, and being respectively movable along said box tracks.

5. The control device as claimed in claim 4, wherein each of said box tracks consists of a plurality of engaging grooves that are disposed in the first direction, each of said box positioning structures being configured as a resilient arm, and removably engages one of said engaging grooves of the corresponding one of said box tracks, such that said receiving box is movable relative to said fixing seat in the first direction, and can be positioned relative to said fixing seat at different positions.

6. The control device as claimed in claim 5, wherein said receiving box of said supporting module defines a power source space therein, said control unit further including a power supplying module, said power supplying module being disposed in said power source space and being electrically coupled to said driving mechanism for providing electric power to said driving mechanism.

7. The control device as claimed in claim 1, wherein said carrying module includes a casing seat, and a cover plate that has said inner surface, said casing seat cooperating with said cover plate to define a retaining space, an installation portion and a connecting portion, said installation portion being formed with a through hole for installation of said operating mechanism, said connecting portion being connected to said supporting module.

8. The control device as claimed in claim 7, wherein said supporting module includes a connecting seat and a fixing seat, said connecting seat being movably sleeved on said connecting portion of said carrying module, and being movable relative to said carrying module in the second direction, said fixing seat being fixedly connected to said connecting seat, a distance between said fixing seat and the door leaf being smaller than that between said inner surface of said carrying module and the door leaf.

9. The control device as claimed in claim 8, wherein the carrying module further includes at least one seat positioning structure that are disposed on a portion of the casing seat partly defining said connecting portion and that are distal from said installation portion, said connecting seat 21 being formed with at least one seat track that extends in the second direction and that corresponds to said seat positioning structure, said seat positioning structure being movable along said seat track.

10. The control device as claimed in claim 9 wherein said seat track consists of a plurality of engaging grooves that are disposed in the second direction, said seat positioning structure being configured as a resilient arm, and removably engaging one of said engaging grooves of said seat track, such that said connecting seat is movable relative to said carrying module in the second direction, and can be positioned relative to said carrying module at different positions.

11. The control device as claimed in claim 8, wherein said transmission mechanism includes a driven gear that is connected to said operating mechanism, a driving gear that is connected to said driving mechanism, and a plurality of intermediate gears that are disposed between and mesh with said driving gear and said driven gear for transmitting power from said driving gear to said driven gear, said intermediate gears being moved during the relative movement between said carrying module and said connecting seat so as to be maintained to transmit power from said driving gear to said driven gear.

12. The control device as claimed in claim 11, wherein said driving mechanism includes a motor that has an output shaft connected to said driving gear, said supporting module further including a motor seat and a receiving box that is able to be retained in said fixing seat, said connecting seat having a base wall, and a fixing wall that is spaced apart from said base wall and that is connected to said fixing seat, said motor seat including a limiting plate that is disposed between said cover plate and said fixing wall of said connecting seat, and a seat body that is fixedly connected to said limiting plate and that projects away from said base wall of said connecting seat, said motor being disposed in said seat body, said receiving box including a power source space, and a passing space that permits said seat body to move therein, said seat body extending through said fixing wall of said connecting seat and a wall of said fixing seat into said passing space, said control unit further including a power supplying module, said power supplying module being disposed in said power source space and being electrically coupled to said driving mechanism for providing electric power to said driving mechanism.

13. The control device as claimed in claim 12, wherein said motor seat is movable relative to said connecting seat in the second direction, said motor seat further including two plate positioning structures that are disposed on said limiting plate, said carrying module further including two plate tracks that are from in a portion of said cover plate partly defining said connecting portion, that extend in the second direction, and that respectively correspond to said plate positioning structures, each of said plate tracks having a first end that is proximate to said installation portion, and a second end that is distal from said installation portion, when said limiting plate of said motor seat projects out of said connecting seat by a minimum extent and when each of said plate positioning structures is located at said first end of said corresponding plate track, said limiting plate being registered with said fixing seat in the first direction, when each of said plate positioning structures is located at said second end of said corresponding plate track, said limiting plate being able to be drawn out from said connecting seat by the relative movement between said connecting portion of said carrying module and said connecting seat.

14. The control device as claimed in claim 12, wherein said fixing seat has two lateral wall segments that are spaced apart from each other, each of said lateral wall segments being formed with at least one box track that extends in the first direction, said receiving box having a box body, and a plurality of box positioning structures that are disposed at two lateral sides of said box body, said box positioning structures respectively corresponding to said box tracks of said lateral wall segments, and being respectively movable along said box tracks.

15. The control device as claimed in claim 13, wherein said fixing seat has two lateral wall segments that are spaced apart from each other, each of said lateral wall segments being formed with at least one box track that extends in the first direction, said receiving box having a box body, and a plurality of box positioning structures that are disposed at two lateral sides of said box body, said box positioning structures respectively corresponding to said box tracks of said lateral wall segments, and being respectively movable along said box tracks.

16. The control device as claimed in claim 1, wherein said carrying module includes a casing seat, and a cover plate that has said inner surface, said casing seat cooperating with said cover plate to define a retaining space, an installation portion and a connecting portion, said installation portion being formed with a through hole for installation of said operating mechanism, said connecting portion being connected to said supporting module, said carrying module further including two seat tracks that are formed in a portion of said cover plate partly defining said connecting portion and that extend in the second direction, each of said seat tracks consisting of a plurality of engaging grooves that are disposed in the second direction, said supporting module including a connecting seat and a fixing seat, said connecting seat being movably sleeved by said connecting portion of said carrying module, and being movable relative to said carrying module in the second direction, said fixing seat being fixedly connected to said connecting seat, a distance between said fixing seat and the door leaf being smaller than that between said inner surface of said carrying module and the door leaf, said carrying module further including a latch module that is disposed on said fixing seat, said latch module including an operating portion that is accessible from the outside of said fixing seat for manual operation, and two latch portions that are connected to said operating portion and that respectively correspond to said seat tracks, each of said latch portions being movable between a locking position where said latch portions engages one of said engaging grooves of the corresponding one of said seat tracks, and an unlocking position where said latch portions is separated from the corresponding one of said seat tracks, each of said latch portions being resiliently retained at the locking position for positioning said carrying module relative to said supporting module in the second direction

17. The control device as claimed in claim 16, wherein each of said latch portions has a connecting segment that is connected to said operating portion, a latch segment that extends from said connecting segment toward said cover plate in the first direction, and an extending segment that extends from said connecting segment away from said cover plate in the first direction, said fixing seat including a main body, and two recesses that are formed in said main body and that respectively receive said extending segments of said latch portions therein, said latch module further including two resilient members that are respectively sleeved on said extending segments of said latch portions, each of said resilient members having two opposite ends respectively abutting against the corresponding one of said connecting segments and an inner surface of said main body of said fixing seat for resilient biasing said latch portions toward the locking position so as to position said carrying module relative to said supporting module in the second direction.

18. The control device as claimed in claim 17, wherein said transmission mechanism includes a driven gear that is connected to said operating mechanism, a driving gear that is connected to said driving mechanism, and a plurality of intermediate gears that are disposed between and mesh with said driving gear and said driven gear for transmitting power from said driving gear to said driven gear, said intermediate gears being moved during the relative movement between said carrying module and said connecting seat so as to be maintained to transmit power from said driving gear to said driven gear, said driving mechanism including a motor that has an output shaft connected to said driving gear, said supporting module further including a motor seat, said motor seat including a limiting plate that corresponds in position to said cover plate, and a seat body that is fixedly connected to said limiting plate and that projects away from said connecting seat, said motor being disposed in said seat body, said fixing seat including a passing space that is formed through said main body and that permits said seat body to move therein.

19. The control device as claimed in claim 18, wherein said fixing seat further includes at least one power source space that is formed in said main body and that opens away from said connecting seat, said control unit further including a power supplying module, said power supplying module being disposed in said power source space and being electrically coupled to said driving mechanism for providing electric power to said driving mechanism, said supporting module further including a cover seat that is able to receive said fixing seat therein, said cover seat including a main seat, and a cap member that is removably mounted to said main seat, said main seat having two spaced-apart cover side walls, each of said cover side walls having at least one cover track that is formed in an inner surface thereof facing toward the other one of said cover side walls, and that extends in the first direction, each of said cover tracks of said cover side walls consisting of a plurality of engaging grooves that are disposed in the first direction, said fixing seat further including a plurality of positioning blocks that are disposed on a periphery of said main body and that respectively correspond to said cover tracks of said cover side walls, each of said positioning blocks removably engaging one of the engaging grooves of the corresponding cover track so as to prevent the relative movement between said fixing seat and said cover seat in the first direction, and being limited to move in the second direction relative to said cover seat so as to be separated from said engaging grooves, the relative movement between said fixing seat and said cover seat in the second direction being prevented when said cover seat is mounted on said main seat, the relative movement between said fixing seat and said cover seat in the second direction being permitted when said cover seat is separated from said main seat.

20. The control device as claimed in claim 18, wherein said limiting plate of said motor seat is disposed at one side of said cover plate opposite to said fixing seat, said limiting plate being formed with two plate tracks, each of said plate tracks consisting of a plurality of engaging grooves that are disposed in the second direction, said carrying module further including two plate positioning structures that are disposed on the cover plate and that respectively correspond to said plate tracks.

21. A control device adapted for operating a door lock that is disposed on a door leaf, the door lock including a base seat that is mounted on and protrudes from an outer surface of the door leaf, and a rotary button that is rotatably mounted to and protrudes from an outer surface of the base seat, said control device comprising:
a casing unit including a carrying module that corresponds in position to the rotary button, and a supporting module that is connected to said carrying module and that is adapted to be mounted to the outer surface of the door leaf, said carrying module having an inner surface that faces the outer surface of the base seat, said supporting module being movable relative to said carrying module in a first direction that is perpendicular to said inner surface, and a second direction that is parallel to said inner surface, said carrying module including a casing seat, and a cover plate that has said inner surface, said casing seat cooperating with said cover plate to define a retaining space, an installation portion and a connecting portion, said supporting module including a connecting seat, a fixing seat and a receiving box, said connecting seat being movably sleeved on said connecting portion of said carrying module, and being movable relative to said carrying module in the second direction, said fixing seat being fixedly connected to said connecting seat, a distance between said fixing seat and the door leaf being smaller than that between said inner surface of said carrying module and the door leaf, said receiving box being able to be retained in said fixing seat, and being movable relative to said fixing seat in the first direction, so that said receiving box is movable relative to said carrying module in the first direction; and
a control unit disposed on the casing unit, and including an operating mechanism, a transmission mechanism and a driving mechanism, said operating mechanism being mounted to said installation portion of said carrying module and associated with the rotary button of the door lock for operating the rotary button, said transmission mechanism including a driven gear that is connected to said operating mechanism, a driving gear that is connected to said driving mechanism, and a plurality of intermediate gears that are disposed between and mesh with said driving gear and said driven gear for transmitting power from said driving gear to said driven gear, said intermediate gears being moved during the relative movement between said carrying module and said connecting seat so as to be maintained to transmit power from said driving gear to said driven gear, said driving mechanism being associated with said transmission mechanism, and being capable of receiving a wireless signal to actuate said operating mechanism via said transmission mechanism, so as to operate the rotary button.

22. The control device as claimed in claim 21, wherein said driving mechanism includes a motor that has an output shaft connected to said driving gear, said connecting seat having a base wall, and a fixing wall that is spaced apart front said base wall and that is connected to said fixing seat, said supporting module further including a motor seat, said motor seat including a limiting plate that is disposed between said cover plate and said fixing wall of said connecting seat, and a seat body that is fixedly connected to said limiting plate and that projects away from said base wall of said connecting seat, said motor being disposed in said seat body, said receiving box including a power source space, and a passing space that permits said seat body to move therein, said seat body extending through said fixing wall of said connecting seat and a wall of said fixing seat into said passing space, said control unit further including a power supplying module, said power supplying module being disposed in said power source space and being electrically coupled to said driving mechanism for providing electric power to said driving mechanism.

23. The control device as claimed in claim 22, wherein said motor seat is movable relative to said connecting seat in the second direction, said motor seat further including two plate positioning structures that are disposed on said limiting plate, said carrying module further including two plate tracks that are from in a portion of said cover plate partly defining said connecting portion, that extend in the second direction, and that respectively correspond to said plate positioning structures, each of said plate tracks having a first end that is proximate to said installation portion, and a second end that is distal from said installation portion, when said limiting plate of said motor seat projects out of said connecting seat by a minimum extent and when each of said plate positioning structures is located at said first end of said corresponding plate track, said limiting plate being registered with said fixing seat in the first direction, when each of said plate positioning structures is located at said second end of said corresponding plate track, said limiting plate being able to be drawn out from said connecting seat by the relative movement between said connecting portion of said carrying module and said connecting seat.

24. A control device adapted for operating a door lock that is disposed on a door leaf, the door lock including a base seat that is mounted on and protrudes from an outer surface of the door leaf, and a rotary button that is rotatably mounted to and protrudes from an outer surface of the base seat, said control device comprising:
a casing unit including a carrying module that corresponds in position to the rotary button, and a supporting module that is connected to said carrying module and that is adapted to be mounted to the outer surface of the door leaf, said carrying module having an inner surface that faces the outer surface of the base seat, said supporting module being movable relative to said carrying module in a first direction that is perpendicular to said inner surface, and a second direction that is parallel to said inner surface, said carrying module including a casing seat, and a cover plate that has said inner surface, said casing seat cooperating with said cover plate to define a retaining space, an installation portion and a connecting portion, said supporting module including a connecting seat, a fixing seat and a cover seat, said connecting seat being movably sleeved by said connecting portion of said carrying module, and being movable relative to said carrying module in the second direction, said fixing seat being fixedly connected to said connecting seat, a distance between said fixing seat and the door leaf being smaller than that between said inner surface of said carrying module and the door leaf, said cover seat being able to receive said fixing seat therein, and being movable relative to said fixing seat in the first direction, so that said cover seat is movable relative to said carrying module in the first direction; and
a control unit disposed on the casing unit, and including an operating mechanism, a transmission mechanism and a driving mechanism, said operating mechanism being mounted to said installation portion of said carrying module and associated with the rotary button of the door lock for operating the rotary button, said transmission mechanism including a driven gear that is connected to said operating mechanism, a driving gear that is connected to said driving mechanism, and a plurality of intermediate gears that are disposed between and mesh with said driving gear and said driven gear for transmitting power from said driving gear to said driven gear, said intermediate gears being moved during the relative movement between said carrying module and said connecting seat so as to be maintained to transmit power from said driving gear to said driven gear, said driving mechanism being associated with said transmission mechanism, and being capable of receiving a wireless signal to actuate said operating mechanism via said transmission mechanism, so as to operate the rotary button.

25. The control device as claimed in claim 24, wherein said carrying module further including a latch module that is disposed on said fixing seat and that is operable to permit or prevent the relative movement between said carrying module and said supporting module in the second direction.
